(19) United States
(12) Patent Application Publication
(10) Pub. No.: US 2025/0094670 A1
(43) Pub. Date: Mar. 20, 2025

(54) MODELING PLATFORM FOR FINITE STATE MACHINE MODELED SYSTEMS

(71) Applicant: GM Global Technology Operations LLC, Detroit, MI (US)

(72) Inventors: Daniel Y. Rubin, Holon (IL); Yael Shmueli Friedland, Tel Aviv (IL); Asaf Degani, Tel Aviv (IL); Shani Avnet, Tel Aviv (IL); Lisa M. Talarico, Milford, MI (US)

(73) Assignee: GM GLOBAL TECHNOLOGY OPERATIONS LLC, Detroit, MI (US)

(21) Appl. No.: 18/469,779

(22) Filed: Sep. 19, 2023

(51) Int. Cl. G06F 30/23; G06F 119/02

(52) U.S. Cl. CPC G06F 30/23; G06F 2119/02

(57) ABSTRACT

A modeling platform for a finite state machine (FSM)-modeled system. The platform may include a design phase module configured for receiving FSM data associated with a design of the FSM-modeled system from a user device, wherein the FSM data describes static properties, dynamic properties, structural properties, states, state transitions, events, and outputs of the FSM-modeled system, wherein the design phase module is configured for generating design data based at least in part on the FSM data. The platform may further include a verification and testing phase module configured for providing a plurality of tools operable for utilizing the FSM and design data to facilitate aiding in design and implementation of the FSM-modeled system according to an identification of undesirable properties and usability deficiencies within the static properties, dynamic properties, structural properties, states, state transitions, events, and outputs of the design.

### INTRODUCTION

The present disclosure relates to a supportive software-based “toolbox” for improving the design and implementation of finite state machine (FSM)-modeled systems having multiple states, state transitions/mode changes, and other potentially complex behavior. The present approach may be advantageous in providing FSM related tools to aid system designers, programmers, and other developers during the system design process.

Finite state machines may be considered as mathematical abstractions used to facilitate designing and validating the behavior of a wide variety of different software programs, physical systems, virtual platforms, simulated processes, and the like. A finite state machine may be graphically represented in an electronic form as a stateflow diagram, state transition table, or hierarchical state machine/diagram, such as a statechart notation. FSM-modeled systems begin from an initial state, and based on the present state of the designed system and a given single event or combination of events (“super events”), a FSM is able to use computer processing to electronically model transition between various additional states in response to system inputs, triggering events, etc. The FSM may be helpful in allowing system designs to test, model, assess, and otherwise study through computer processes different aspects of the modeled system before the modeled system is physically constructed. This capability to use FSM to model a system in the computer realm prior to use of the modeled system in the physical realm may be beneficial in minimizing issues, improving build time, maximizing performance, testing, etc. Although the state transition table or stateflow diagram may be instrumental to the overall system design process, particularly with larger systems, such as an autonomous driving system operable for autonomously operating a vehicle, the quantity of possible states, transitions, rules, etc. may exceed capabilities of designers to generate, interact, assess, and otherwise process the FSM-modeled system in a way that is meaningful.

### SUMMARY

One non-limiting aspect of the present disclosure relates to a modeling system configured for providing a supportive software-based “toolbox” for aiding in the design and implementation of finite state machine (FSM)-modeled systems, such as with processor or other computer-based automation and analysis tools capable of leveraging software to improve the limited capabilities of designers so as to meaningfully interface with testing scenarios, reports, and other information for a FSM-modeled system.

One non-limiting aspect of the present disclosure relates to a modeling platform for a finite state machine (FSM) based modeling platform. The modeling platform may include a design phase module configured for receiving FSM data associated with a design of a FSM-modeled system. The FSM data may describe static properties, dynamic properties, structural properties, states, state transition rules, events, and outputs of the FSM-modeled system. The design phase module may be configured for generating design data based at least in part on the FSM data. The modeling platform may further include a verification and testing phase module configured for providing a plurality of tools operable for utilizing the FSM and design data to facilitate aiding in design and implementation of the FSM-modeled system according to an identification of undesirable properties and usability deficiencies within the static properties, dynamic properties, structural properties, states, state transition rules, events, and outputs of the design.

The design phase module may include an input module configured for receiving inputs entered by one or more developers to be included as part of the FSM data

The design phase module may include a state definition module configured for importing or otherwise generating semantic information regarding each state of the design including state outputs.

The design phase module may include a containers assignment and nesting module configured for indicating hierarchy and relations between states according to separately identifiable groupings of the states

The design phase module may include a state transition table module configured for defining a state transition table for the design.

The verification and testing module may include a multiplication queries module configured for identifying situations based on combinations of specific event values for one or more of the states.

The verification and testing module may include a generation of an abstraction table configured for defining constructs suitable for portraying possible states that occur upon a given event.

The verification and testing module may include a stateflow diagram generation module configured for creating an initial diagram of the design to serve as a first draft toward follow-up modification and enhancement.

The verification and testing module may include a scenario testing module configured for conducting multiple time-simulation tests of the design based on different events triggered according to a set of scenarios.

The verification and testing module may include an evaluation module configured for identifying existence of desirable as well as undesirable properties relative to an affected portion of the design.

The verification and testing module may include a usability module configured for assessing whether states and transitions comply with corresponding guidelines encapsulated within a set of defined properties.

The verification and testing module may include a pattern identification module configured for collecting information from alternative designs for comparison to the design.

One non-limiting aspect of the present disclosure relates to a modeling platform for a finite state machine (FSM)-modeled system. The modeling platform may include a design phase module configured for receiving FSM data associated with a design of the FSM-modeled system from a user device. The FSM data may describe static properties, dynamic properties, structural properties, states, state transition rules, events, and outputs of the FSM-modeled system, wherein the design phase module is configured for generating design data based at least in part on the FSM data. The modeling platform may include a scenario testing module configured for analyzing the FSM and design data to facilitate aiding in design and implementation of the FSM-modeled system based at least in part on subjecting a tested portion of the design to a testing scenario whereby events specified in an event timeline to identify undesirable properties and usability deficiencies within the static properties, dynamic properties, structural properties, states, state transition rules, events, and outputs of the tested portion.

The scenario testing module may perform an events time sequence process to detail specific testing events sequence to be include in the testing scenario, optionally with the testing events therein being entered or automatically generated, and an executable model process to detail an executable model for the testing scenario.

The scenario testing module may perform a time simulation process based on pre-processing inputs from the events time sequence process and the executable model process, optionally with the time simulation process including a plurality of time sub-processes for performing the scenario testing.

The time sub-processes may include an initial state process, a read event process, an advance model process, an output process, a check verification rules process, and record new state process.

The scenario testing module may perform a post-time process on time simulation inputs resulting from the time simulation process, optionally with the post-time process including a plurality of post-time sub-processes for identifying undesirable properties and usability deficiencies within the static properties, dynamic properties, structural properties, states, state transitions, events, and outputs of the testing scenario.

The post-time sub-processes may include a display output process, a verify results against specifications process, a usability analysis process, and a usability analysis process.

The scenario testing module may include a verification and testing phase module, the verification testing phase module additionally including a multiplication queries module, a generation and abstraction table module, a stateflow diagram generation module, an evaluation module, a usability module, and a pattern identification module.

One non-limiting aspect of the present disclosure relates to a modeling platform for a finite state machine (FSM)-modeled system. The modeling platform may include a design phase module configured for receiving FSM data associated with a design of the FSM-modeled system from a user device. The FSM data may describe static properties, dynamic properties, structural properties, states, state transition rules, events, and outputs of the FSM-modeled system, wherein the design phase module is configured for generating design data based at least in part on the FSM data. The modeling platform may further include a verification and testing phase module configured for providing a plurality of tools operable for utilizing the FSM and design data to facilitate aiding in design and implementation of the FSM-modeled system according to an identification of undesirable as well as desirable properties and usability deficiencies within the static properties, dynamic properties, structural properties, states, state transitions, events, and outputs of the design. The modeling platform may yet further include an evaluation module configured for interfacing results of the verification testing phase module with a user.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a modeling system for finite state modeling in accordance with one non-limiting aspect of the present disclosure.

FIG. 1A illustrates an exemplary embodiment of distributed processing nodes for use in implementing the modeling system in accordance with one non-limiting aspect of the present disclosure.

FIG. 2 illustrates an exemplary screen for an event definition stage of the methodology described herein in which events/inputs are defined by a user of the representative modeling system in accordance with one non-limiting aspect of the present disclosure.

FIG. 3 illustrates another exemplary table for summarizing events in accordance with one non-limiting aspect of the present disclosure.

FIG. 4 illustrates a possible screen for use in a state definition stage according to in accordance with one non-limiting aspect of the present disclosure.

FIG. 5 illustrates a function of the modeling system when grouping states into different containers of meaning in accordance with one non-limiting aspect of the present disclosure.

FIG. 6 depicts a possible implementation of a compound/super-event definition stage in accordance with one non-limiting aspect of the present disclosure.

FIG. 7 is a simplified representative state transition table in accordance with one non-limiting aspect of the present disclosure.

FIG. 8 illustrates a possible approach for implementing customed queries via the modeling system in accordance with one non-limiting aspect of the present disclosure.

FIG. 9 is a flow chart describing data entry and automatic error checking in accordance with one non-limiting aspect of the present disclosure.

FIG. 10 illustrates a feedback table in accordance with one non-limiting aspect of the present disclosure.

FIG. 11 illustrates a distinctiveness abstraction table in accordance with one non-limiting aspect of the present disclosure.

FIG. 12 illustrates a flowchart of a method for characterizing notification distinctiveness in accordance with one non-limiting aspect of the present disclosure.

FIG. 13 illustrates a flowchart of a method for design optimization in accordance with one non-limiting aspect of the present disclosure.

FIG. 14 illustrates a flowchart of a method for model verification in accordance with one non-limiting aspect of the present disclosure.

FIG. 15 illustrates a flowchart of a method for pattern recognition in accordance with one non-limiting aspect of the present disclosure.

FIG. 16 illustrates a flowchart of a scenario testing method in accordance with one non-limiting aspect of the present disclosure.

FIG. 17 illustrates an overall modeling platform in accordance with one non-limiting aspect of the present disclosure.

### DETAILED DESCRIPTION

The present disclosure may be embodied in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

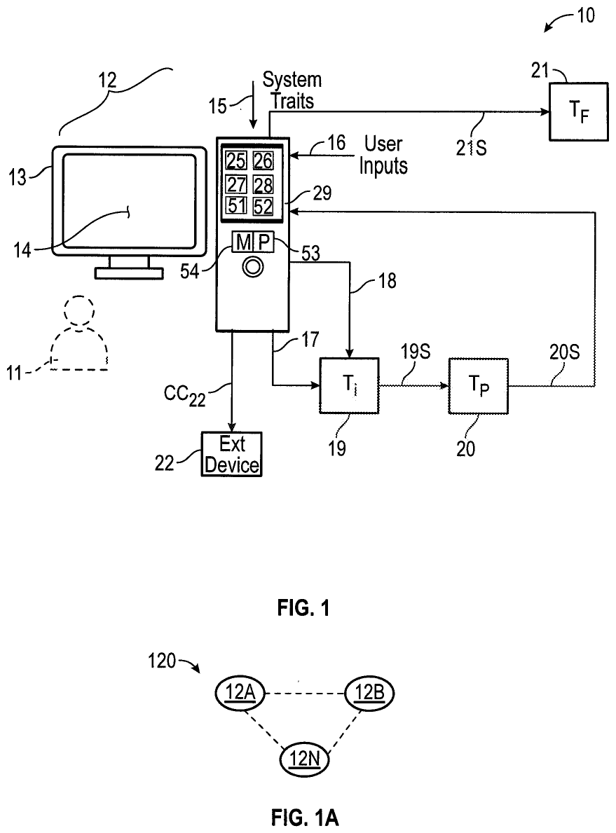

Referring to the drawings, wherein like reference numbers refer to like features throughout the several views, FIG. 1 depicts a modeling system 10 configured to facilitate design of a finite state machine (FSM)-modeled system. Due to the criticality of achieving a sound design, especially as close to a perfect understanding and implementation of a designed system as is possible in the context of high risk design process, and to develop systems that are free of incorrect structures that can lead to design errors and incorrect user interaction, it may be useful to verify that the designed system and associated human-machine interfaces will behave in a logical manner and in a way that their behavior is expected by end-users (a user 11, e.g., a designer or programmer, as opposed to a driver, pilot), or other end user of a physical embodiment of the modeled system. An ability to recognize patterns in the FSM-modeled system, or what may be generically referred to herein as system patterns, may be supportive in providing a software-based “toolbox” for aiding a design team.

To that end, the present solutions make it possible for the user 11 to optimize design of the FSM-modeled system. Additionally, the presented approach supports a structured hierarchical design of the modeled system as set forth herein. As described in detail below, the system 10 as contemplated herein has a goal of automatic design of efficient/usable systems based on preferences indicated by users over several configurations, optionally leveraging structural properties that exist in models for predicting effectiveness. The contemplated optimization may include generating large numbers of combinations and searching through the combination space using local search, genetic algorithms, and the like for advancing and converging the design to an optimized design for the FSM-modeled system. The present disclosure, accordingly, may be operable to provide a modeling system configured for providing a supportive software-based “toolbox” for aiding in the design and implementation of FSM-modeled systems, such as with processor or other computer-based automation and analysis tools capable of leveraging software to improve the limited capabilities of computer system to meaningfully interface testing scenarios, reports, and other information for FSM-modeled system designers, programmers, etc.

The modeling system 10 illustrated in FIG. 1 may include a user device 12, e.g., a laptop computer, tablet computer, desktop computer, mobile application (“app”), or another application-suitable host machine configured for assisting the user 11 in the design of potentially complex hardware and/or software-based system. Although the user device 12 is depicted in FIG. 1 as a single computer device for illustrative simplicity, those skilled in the art will appreciate that the user device 12 could be implemented as a distributed user device 120 having multiple processing nodes, e.g., 12A, 12B, . . . , 12N, as depicted schematically in FIG. 1A. Such processing nodes may be in communication with one another over suitable wired, wireless, and/or cloud-based networked connections. The modeling system 10, and underlying systems, may be used for benefitting the design of human-machine interfaces (“HMIs”) or other devices onboard a motor vehicle or an aircraft, watercraft, rail vehicle, or another dynamic system, or to model performance of a medical device, powerplant, or another static system.

The modeling system 10 illustrated in FIG. 1 may also include one or more peripheral devices 13, including a display screen 14 operable as an output device for the user device 12. The user 11 may interact with the user device 12 via one or more additional peripheral devices 13 (not shown), e.g., a mouse, keyboard, touch inputs to the display screen 14, etc., when developing or designing state transition tables for the FSM-modeled system, including functions of resident software and/or hardware thereof. As appreciated in the art, the task faced by the user 11 when designing an application-suitable FSM model is often complicated by the sheer complexity of the FSM-modeled system. For example, while operation of a binary system such as an on/off table lamp could be represented by its two possible states (“on” and “off”), two possible state transitions (“on-to-off” and “off-to-on”), and two inputs or events (“switch turned off” and “switch turned on”), the accurate FSM modeling of more complex systems could require the same user 11 to consider hundreds or thousands of different states, state transitions, events, and other possible system traits. It is thus possible that the user 11 could inadvertently overlook or omit one or more states, state transitions, or event combinations (“super-events”), which in turn could degrade the performance and quality of the modeled system.

The present solutions therefore facilitate the design and development of FSMs and corresponding state transition tables to allow the user 11 to fully define the possible states, set a hierarchy of such states in an intuitive manner, and ultimately construct and error-test the state transition table in a comprehensive manner. Among the many possible attendant benefits of the present solutions, the user 11 may be guided into considering function-critical states with highlighting of potential errors or omissions (“critical traits”). As noted above, additional error-checking functionality may be provided within the scope of the disclosure, including validation of state transitions per event type for states that belong to a certain container as described below, and highlighting critical events and states to help identify transitions of critical events to non-critical events, and in general, to look more thoroughly at such highlighted transitions.

As part of the present strategy, the host computer 12 of FIG. 1 or its constituent processing nodes 12A, 12B, . . . , 12N of FIG. 1A may be equipped with an error-checking module (“ECM”) 52, non-tangible computer-readable storage medium or memory (M) 54, and one or more processors (P) 53, e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The associated memory 54 may include application-suitable amounts and types of non-transitory memory inclusive of read only, programmable read only, random access, a hard drive, etc., whether resident, remote or a combination of both.

As described herein, the host computer 12 is configured to receive system traits 15 from the user 11. This could entail receiving various states, state transitions, and events of the modeled system, along with a possible super-events (event combinations), a hierarchy definition, and other system traits 15. In response to the received system traits 15, the host computer 12 automatically generates and outputs a first data set 17 embodying a blank/unpopulated initial state transition table (Ti) 19. This initial state transition table 19 is indexed by as complete of a population of possible states and events of the modeled system as possible, and with the system traits 15 entered by the user 11. Additionally, the host computer 12 automatically populates the initial state transition table 19 with a second data set 18 to thereby generate a third data set 19S, the third data set 19S including a populated state transition table (“T_{P}”) 20.

That is, the host computer 12 automatically generates (“auto-generates”) the populated state transition table 20 as the third data set 19S. This occurs in response to a set of user inputs 16. After performing one or more iterations of a method 100, the host computer 12 ultimately outputs a final state transition table (T_{F}) 21. The final state transition table 21 is then used as needed, typically as a starting point for further investigation by the user 11 and to serve as a basis for developing a state diagram and scenario simulations for the modeled system.

As part of the disclosed solutions, the host computer 12 shown schematically in FIG. 1 processes the third data set 19S through the ECM 52 to error-check the populated state transition table 20. This action occurs using predetermined error-checking criteria. For instance, the host computer 12 could search the populated state transition table 20 for omitted critical traits, e.g., an omitted state, state transition, event, and/or other trait(s) of a system-critical or function-critical component of the modeled system. The host computer 12 may also communicate an alert signal (CC₂₂) to the display screen 14 or to an external device (“Ext Device”) 22 such as a smart phone or one of the various processing nodes 12A, 12B, . . . , 12N of FIG. 1A as part of the present strategy as noted below, with such an optionally action occurring in response to the omitted critical trait.

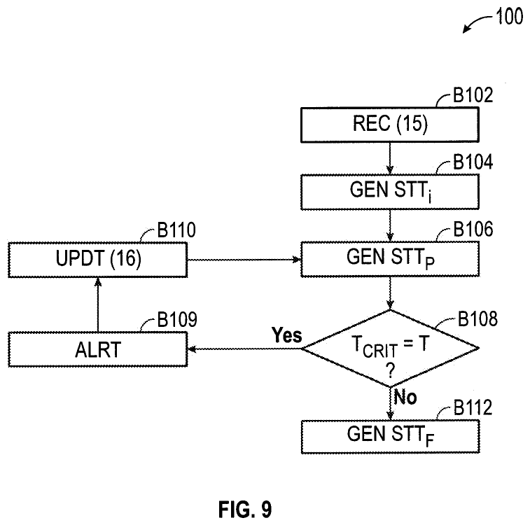

Additional error-checking functionality may be included, such as the aforementioned validation of state transitions per event type for states that belong to a certain container as described herein, and highlighting critical events and states to help identify transitions of critical events to non-critical. A non-limiting exemplary implementation or method 100 in accordance with the present teachings is shown in FIG. 9. As will be appreciated by those skilled in the art having the benefit of the forgoing disclosure, the method 100 and its execution by the host computer 12 provide an improvement in computer-related technology related to FSM-based modeling of systems and associated functions. This improvement is achieved in part by enabling computer performance of functions not previously performable in this capacity. The particular solutions set forth above achieve the desired outcome of a complete and error-proofed state transition table, i.e., the final state transition table 21.

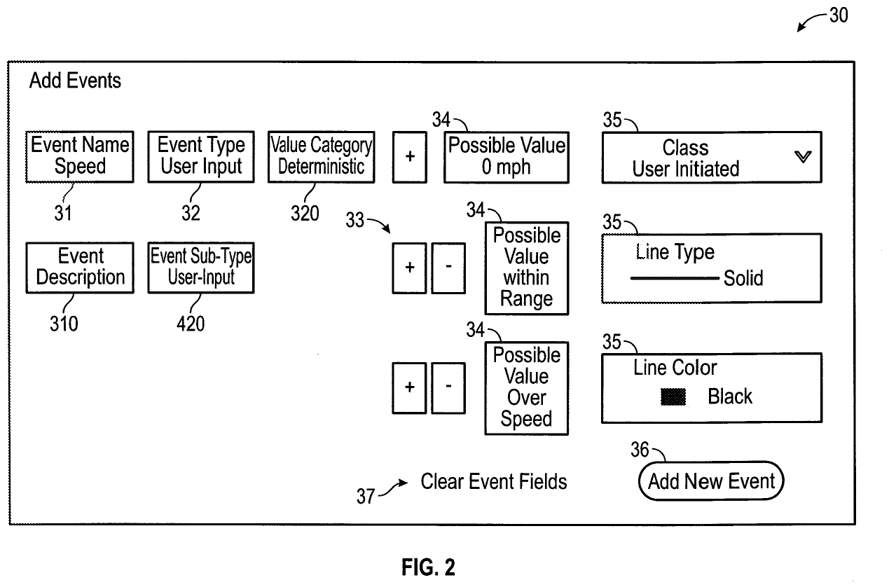

DEFINING EVENTS: referring now to FIG. 2, a representative event input screen 30 could be presented to the user 11 via the display screen 14 of FIG. 1 as part of the present approach. An aim of this particular step is to properly define the events in the modeled system. To that end: (1) events are organized into one of three categories: (i) User-initiated, (ii) System-triggered, and (iii) Timeout; (2) the event type will be (i) a user event (for the User-initiated category), (ii) a machine status, sensor status, environmental conditions, external event, etc. (for the System-triggered category), or (iii) user readiness, triggered timer, and independent timer (for the Timeout event category). Finally, (3) the value with be (i) Deterministic, as string of text and/or numbers, (ii) Boolean, i.e., true or false, or (iii) Integer, including logical properties such as ≥, <, =, etc.

Before the user 11 enters the system traits 15, the host computer 12 could first present the input screen 30 as a set of user-selectable buttons. For instance, the user 11 could add a new event via an Event Name button 31, which is labeled “speed” in FIG. 2 to describe a non-limiting example event in which the modeled system is a motor vehicle. An Event Description button 310 may be used to further define the event. A Value Category button 320, e.g., deterministic as shown, could be present on the representative “Add Events” screen of FIG. 2. The user 11 could then define the event type via an Event Type button 32 and an Event Sub-Type button 420, e.g., “User-input” as shown, selecting an add or “+” action via a corresponding selection button 33. Value Buttons 34 could be selected to add corresponding possible values, e.g., “0 mph”, “within range”, and “over speed” in the illustrated example of FIG. 2. The user can define these according to needs, etc., as there is more than one way to define such an event.

The input screen 30 could likewise present several Event Class buttons 35 to enable the user 11 to define whether a given event is a user-initiated category as specified above, or automatically occurring such as in response to a timer, external/environmental, fault-triggered, etc. The various classes could be assigned a given line weight/style (dashed, solid, dotted, etc.) or color, which are then used to connect states in a corresponding state transition diagram. Additional buttons could be used with input screen 30 of FIG. 2 for other purposes, such as but not limited to an Add New Event button 36 and a Clear Event Fields button 37.

Collectively, the buttons 31-37 in the non-limiting embodiment of FIG. 2 allow the user 11 of FIG. 1 to initially define the events or inputs for use by the host computer 12 of FIG. 1 when constructing a state transition diagram of a modeled system. The method 100 could include presenting a menu of possible states and events of the modeled system via the display screen 14, with the menu possibly being configured to receive touch or keyboard inputs from the user 11, and then determining the system traits 15 noted above using such touch or keyboard inputs. This could include displaying the menu as a drop-down list, in which case receiving the system traits 15 includes recording user entries or selections from the drop-down list, e.g., in the memory 54 of the host computer 12. The user 11 could also restrict values according to their appropriateness to the above-noted Value category.

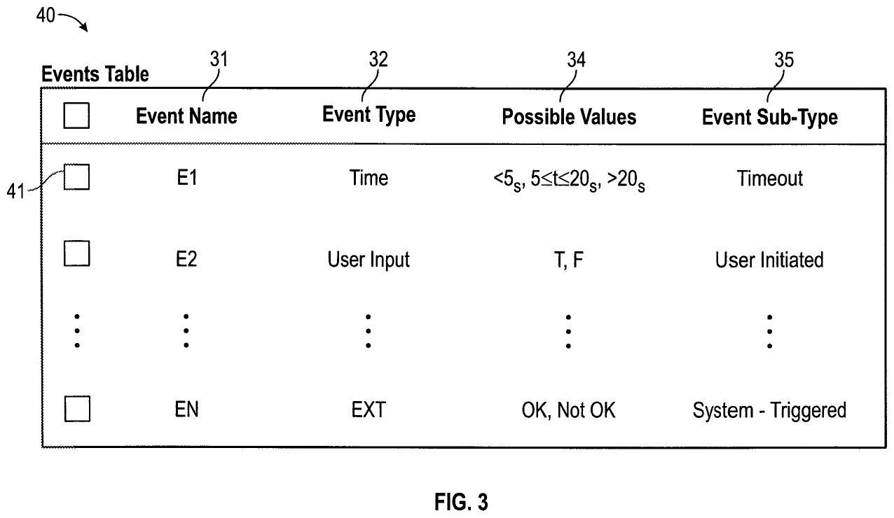

Referring briefly to a representative Events Table screen 40 of FIG. 3, in response to completion of data entry using the exemplary input screen 30 of FIG. 2, the host computer 12 could present a representative event screen 40 via the display screen 14 of FIG. 1. Possible event values as described above include Deterministic, Boolean, and Integer. To that end, the Events Table screen 40 could include columns corresponding to the above-described buttons of FIG. 2, e.g., an Event Name button 31, Event Type button 32, Possible Values button 34, and Event Sub-type button 35. The event screen 40 could also include selection boxes 41 corresponding to each event name, e.g., nominal events E1, E2, . . . , EN.

Non-limiting exemplary event types for a representative modeled system include user events (for the User-initiated category), machine status, sensor status, environmental conditions, external events, etc., (for the System-triggered event category), or user readiness, triggered timer, and independent timer for the Timeout event as noted above. As an illustration of some of these events, “Time” represents a nominal timeout event E1, “User Input” a nominal user event E2, and “Ext” represents the N^{th} nominal event EN, e.g., an external event or environmental event. Possible Values 34 for nominal event E1 in this representative case may be one or more time thresholds or ranges, such as with the illustrated example ranges of <5s, 5s≤t≤20s, >20s, or true or false (T, F) for nominal event E2, or “OK, Not OK” for nominal event EN. Exemplary class events that may be entered by the user 11 via the Class (or Event) button 35 may include, by way of an example, “User-Initiated”, “System-Triggered” as shown, or “Timeout”. Thus, the representative event screen 40 could present events for each state transition, which the user 11 of FIG. 1 may edit from the event screen 40 simply by adding, deleting, or modifying one or more of the rows.

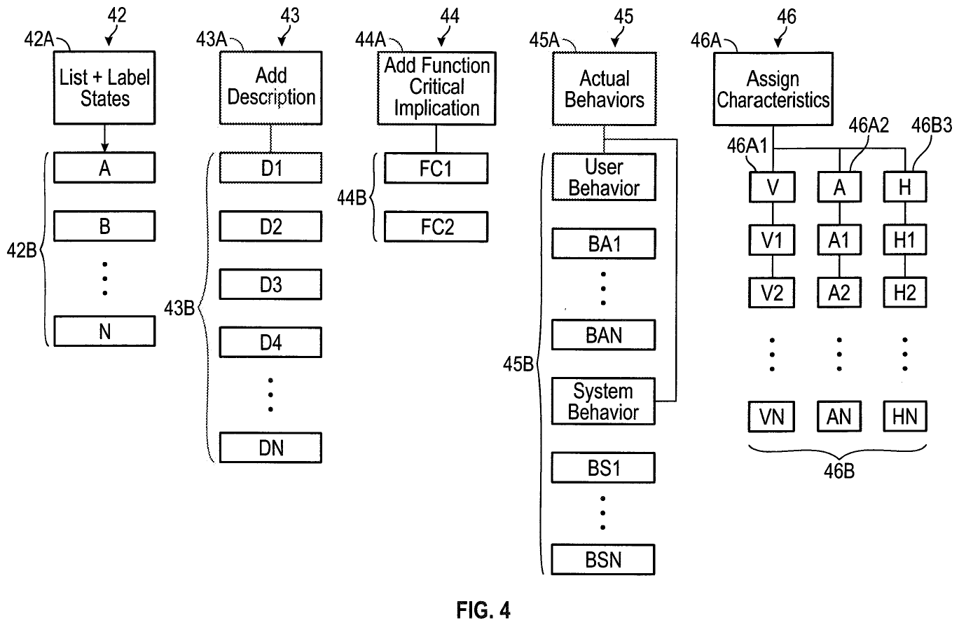

DEFINING STATES: as illustrated in FIG. 4, the possible states of the finite state-modeled system may be defined by the user 11 of FIG. 1 using the host computer 12. In a non-limiting illustrative example, the user 11 may view and select from a “List+Label States” column 42 having a main selection button 42A from which the user 11 is able to select or enter multiple states 42B, e.g., nominal states A, B, . . . , N, with the identity of the states being application-dependent as appreciated in the art. An “Add Description” column 43 with a main selection button 43B enabled the user 11 to select one or more corresponding state descriptions 43B labeled as nominal state descriptions D1, D2, D3, D4, . . . , DN. In keeping with the non-limiting embodiment of a motor vehicle as the modeled system, for instance, such descriptions could include “available” (or “standby”), “active”, “escalation”, etc. Additionally, the user 11 could utilize an “Add Critical Function” column 44 with main selection button 44A to define critical functions or implications 44B labeled as nominal functions FC1 and FC2, e.g., responsiveness levels of an end-user or system.

Still referring to FIG. 4, the user 11 of FIG. 1 could also view and edit an “Actual Behaviors” column 45 with a corresponding main selection button 45A to define behaviors 45B, e.g., nominal user behaviors BA1, . . . , BAN and/or nominal system behaviors BS1, . . . , BSN. Representative user behaviors in the same vein as the above-summarized motor vehicle illustrative example may include “full control”, “lateral control”, “longitudinal control”, “no control”, etc., with representative system behaviors possibly including, e.g., “maintain speed”, “coasting”, or “smart deceleration”, among many other possible application-specific behaviors. In addition to columns 42, 43, 44, and 45, the user 11 shown in FIG. 1 could use an “Assign Characteristics” column 46 and a main selection button 46A to assign characteristics 46B. Such characteristics could be arranged as distinct types such as visual characteristics (V) 46B1, auditory characteristics (A) 46B2, and haptic characteristics (H) 45B3, with each of the characteristic types having one or more selected characteristics.

For example, the user 11 could select, for the visual characteristics 46B1, a list of specific nominal visual characteristics V1, V2, . . . . VN, e.g., “color”, “saturation”, “amplitude”, “envelope shape”, etc. Similarly, the auditory characteristics 46B2 could include nominal auditory characteristics A1, A2, . . . , AN, for example “timbre”, “frequency”, “envelope shape”, “directionality”, and the like. The haptic characteristics 45B3 for their part could include nominal haptic characteristics H1, H2, . . . , HN. The user 11 is thus able to define the various system states for use by the host computer 12 in generating and iteratively error-checking and updating one or more state transition tables.

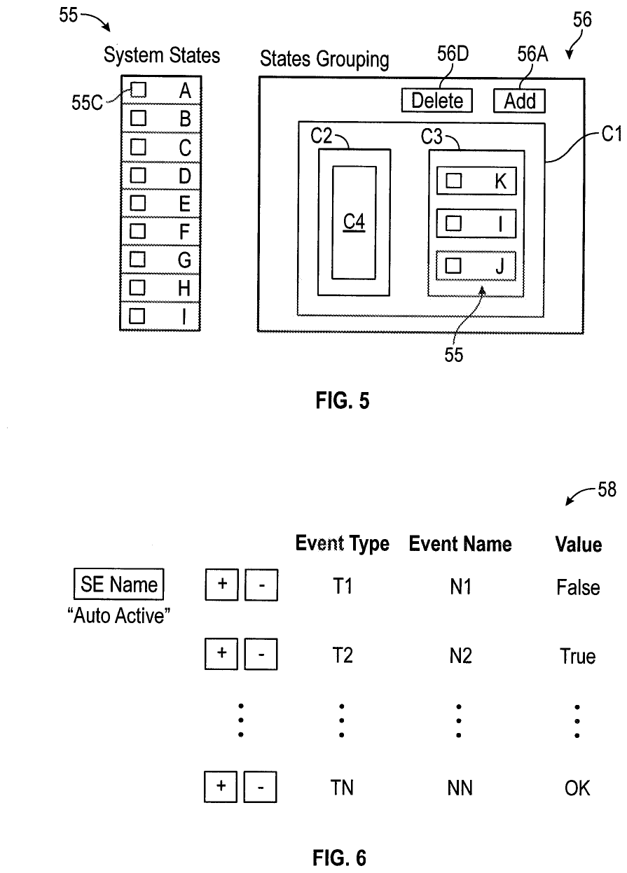

GROUPING OF STATES: referring now to FIG. 5, the host computer 12 depicted in FIG. 1 could then present to the user 11 a complete list of the previously-selected system states 55, which are labeled as nominal states A-I for simplicity. Each of the states 55 has a corresponding selection box 550 in this representative implementation, which when selected would allow the user 11 to select and manipulate the states 55 into a desired hierarchy. The host computer 12 in one or more embodiments receive user-defined containers of meaning (“containers”) in which two or more of the states 55 from FIG. 4 are grouped together. The host computer 12 could then translate the user-assigned containers into a corresponding state hierarchy.

To facilitate this optional approach, the host computer 12 could be configured to display an intuitive drag-and-drop graphic 56 via the display screen 14 shown in FIG. 1, for instance as rectangular containers C1, C2, C3, and C4. The host computer 12 could then group one or more of the illustrated example containers C1, C2, C3, and/or C4 as a user response to the drag-and-drop graphic 56. For example, the exemplary states 55 nominally labeled as K, I, and J in FIG. 5 could be arranged into the container C3, with the container C1 containing containers C2 and C3, and container C2 including an (empty) container C4. The user 11 can thus construct a hierarchy of states in an intuitive manner, with functions such as “Delete” and “Add” included via corresponding buttons 56D and 56A to add and delete new containers. Adding or deleting States to/from the containers could be performed using a “drag & drop” function, or possibly using typical cut, copy, and paste editing tools functions. The host computer 12 could also confirm the validity of the various state transitions per event type in each respective one of the containers as an added function, thereafter communicating a validity confirmation status to the user 11, e.g., as part of the alert signal (CC₂₂) of FIG. 1, with this action occurring in response to confirming the validity of the state transitions.

DEFINING SUPER-EVENTS: the user 11 of FIG. 1 in accordance with the disclosure could also combine multiple inputs or events, such as concurrent user-generated, automatically-generated, or externally-generated events. This action may entail receiving, via the host computer 12, a user-defined compound event or “super-event” as a combination of two or more previously-defined events. For instance, the user 11 could note the specific conditions that must occur before the modeled system is able to transition to a new state, such as from nominal state A of FIG. 5 to nominal state B. As an example, even though every other condition has been satisfied for transitioning from state A to state B, a “blocked camera” condition could prevent the modeled system from transitioning to an “automatic drive mode” in an exemplary motor vehicle use case. The host computer 12 could then update the populated state transition table 20 of FIG. 1 with the user-defined compound events in accordance with an aspect of the disclosure.

Referring to FIG. 6, the above-noted super-events could be constructed by the user 11 of the host computer 12 of FIG. 1 using yet another user screen 58. Here, the user 11 could define a super-event name such as “auto-active”, add or delete an event type using corresponding “+” or “−” buttons, and define the event type(s) associated with each new super-event. For example, nominal event types T1, T2, . . . , TN could be considered together as part of an “Auto Active” super-event, with assigned nominal event names N1, N2, . . . , NN and associated values, e.g., “False”, or “True”, . . . , “OK”, etc. The user 11 could therefore use the illustrated screen 58 as an aid toward developing one or more super-events as part of the present approach, which would enable automated error checking functionality while avoiding conflicting or racing conditions. The user 11 would also be free to explore possible multiplications of events and export the results to the updated state transition table 20 of FIG. 1. This approach would also highlight interesting interactions between critical events.

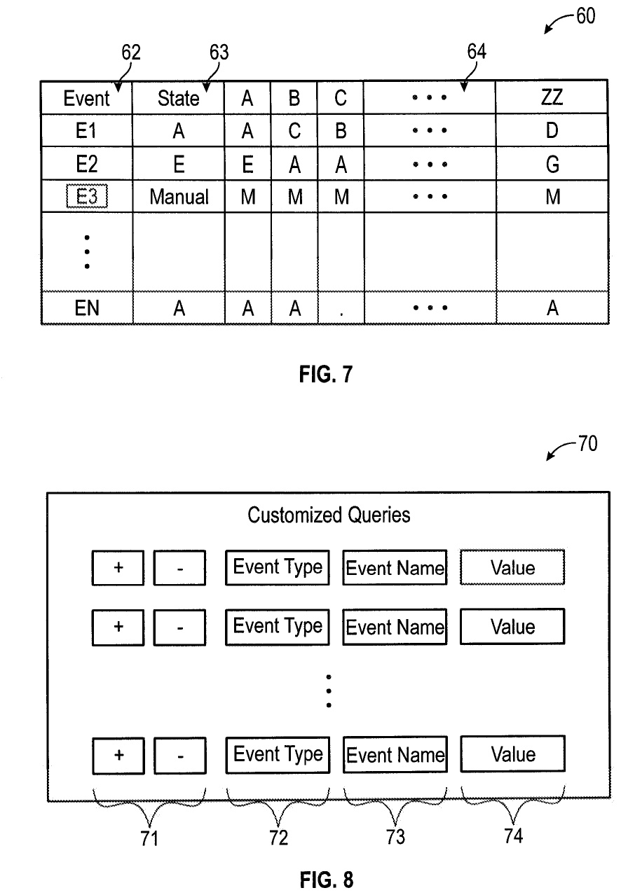

GENERATING STATE TRANSITION TABLE: referring to FIG. 7, the various state tables 19, 20, and 21 shown schematically in FIG. 1 may be visualized as a simplified state transition table 60. In this exemplary illustration, the state transition table 60 is organized into a row of nominal states 64, e.g., A, B, C, . . . , ZZ for simplicity, and an “event” column 62 containing nominal events E1, E2, E3, . . . , EN, with events described above with reference to FIGS. 2 and 3. Each event in column 62 in turn could trigger a transition to a corresponding state in column 63. For instance, event E2 occurring in state A could cause the modeled system to transition to state E in the illustrated state transition table 60. As part of the present approach, each of the states defined by the user 11 are listed in the exemplary state transition table 60.

In a possible approach, super-events as described above could be color-coded to distinguish them from regular events when displayed in the state transition table 60 of FIG. 7. Additionally, the user 11 is able to access the state transition table 60 and edit it directly, for example in response to a prompt from the host computer 12 of FIG. 1 indicating an omitted critical state, state transition, or event. That is, the host computer 12 could allow the user 11 to edit the state transition table 60 from within, e.g., by opening a drop-down menu in response to the user 11 selecting a particular state or event from the state transition table 60. This functionality is illustrated for simplicity at nominal event E3, via its boxed outline, and the notation “Manual” or “M” indicating the possibility of the user 11 editing or entering corresponding states into the state transition table 60. The user 11 is thus guided when constructing, populating, error-checking, and updating the state transition table 60, with such actions occurring iteratively through the method 100 described below with reference to FIG. 9.

The host computer 12 of FIG. 1 could, after displaying the state transition table 60 of FIG. 7, highlight omitted critical states or other critical traits, as well as prompt the user 11 to address any states that might have been missed in the initial definitions. For example, the ECM 52 depicted in FIG. 1 could be used for this purpose to enable the host computer 12 to automatically check the state transition table 60 for a lack of consistency and/or completeness. As part of this possible implementation, the host computer 12 could be configured to check the validity of the various state transitions per event type as noted above, and to examine for states that belong to a certain container or containers (see FIG. 5). Highlighting critical events and critical states would help the user 11 properly identify state transitions from critical to non-critical state in response to the various events. Also note that filters may be used, or marking of critical events, critical states, and their intersection, and the ability to edit events and super-events from with the page, etc.

CUSTOMIZED QUERIES: the user 11 of the host computer 12 depicted in FIG. 1 may also perform customized queries as part of the present approach. This capability enables further stress-testing of the state transition table 60 of FIG. 7 during design and development of finite state models, allowing the user 11 to explore a myriad of possible event combinations that the modeled system could conceivably encounter during actual operation. This could include receiving a customized event query from the user 11 via the host computer 12, with the customized event query describing one or more hypothetical combinations of the events. The host computer 12 could determine results of the event query and update the populated state transition table 20 of FIG. 1 with the results.

To this end, a simplified query screen 70 is illustrated in FIG. 8 having add and delete buttons 71 (+, −), “Event Type” buttons 72, “Event Name” buttons 73, and “Value” buttons 74. Using the query screen 70 or a similar interface, the user 11 could construct multiple combinations of events, whether alone, in a particular sequence, or as the above-described super-events. The user 11 could select an interesting combination, name it, and save it as a new line in the state transition diagram. The host computer 12 may then update lines in the state transition table 60 (FIG. 7) that the user 11 may thereafter view and evaluate for omitted critical traits as set forth above. This approach would help guide the user 11 toward overlooked or omitted traits, at least some of which could be considered function-critical and thus deserving of a specific entry or entries in the state transition table 60 and state transition diagrams stemming therefrom.

Referring now to FIG. 9, the method 100 of the present disclosure is shown in simplified form as being organized into discrete logic blocks. Each logic block in turn represents a particular process step, function, or subprocess to be performed by the host computer 12 of FIG. 1 when executing the present method 100. That is, the memory 54 of the host computer 12 is programmed with or otherwise includes an instruction set that is executable by the processor(s) 53. As noted above, the host computer 12 could be embodied as multiple digital computer systems or processing nodes, e.g., processing nodes 12A, 12B, . . . , 12N of FIG. 1A, e.g., as part of a distributed computing network, or the host computer 12 could be a standalone device such as a laptop or user workstation. Thus, the constituent logic blocks of FIG. 9 may be implemented as machine-readable code that is executed by the host computer 12 or one or more of the processing nodes 12A, 12B, . . . , 12N, without limitation.

Beginning with block B102 (“REC (15)”), the method 100 entails receiving the system traits 15 from the user 11 illustrated in FIG. 1. The system traits 15 could include user-defined states of the modeled system, along with various state transitions, triggering events, and possibly other traits. Block B102 could include presenting a menu of the possible states and events via the display screen 14, e.g., by displaying the menu as an intuitive drop-down list, with the display screen 14 and/or the host computer 12 of FIG. 1 being configured to receive touch and/or keyboard inputs from the user 11, with such inputs being indicative of the system traits. The host computer 12 could then determine the system traits 15 using the touch or keyboard inputs, for instance by reading user entries or selections from the drop-down list.

Depending on the application, receiving the system traits 15 could entail receiving user-initiated events, automatically-occurring events, or external events, and fault-triggered events of the modeled system. Non-limiting exemplary user-initiated events when the modeled system is a motor vehicle having automated drive system capabilities, for instance, could include accelerator and brake pedal position/force, steering inputs, HMI button or knob states, etc. Automatically-occurring events could include timer, sensor, fault-triggered, while external/environmental could include roads, weather, etc.

At block B102, therefore, the user 11 of FIG. 1 assigns event rules states, escalations or transitions between different states, classes (e.g., line weights, styles, and colors for use in constructing a corresponding state transition diagram), etc. The defined states and events/inputs are used to create an empty state table, for which the user 11 will ultimately select states using a drop-down list or menu. The method 100 proceeds to block B104 after the host computer 12 has received the system traits 15.

Block B104 (“GEN STTi”) includes generating the initial state transition table 19 of FIG. 1 in response to receipt of the system traits 15, with this action performed by operation of the host computer 12. The initial state transition table 19 is indexed, i.e., referenced on corresponding row/column axes, by a complete population of states and events of the modeled system, and then partially-populated with the system traits 15 as entered by the user 11 at block B102. The initial state transition table 19 of block B104 possibly lacks some or all of the assigned states of the exemplary state transition table 60 shown in FIG. 7, i.e., the initial state transition table 19 is substantially blank, awaiting further data entry by the user 11. Method 100 then proceeds to block B106.

At block B106 (“GEN STT_{P}”), the method 100 includes populating the initial state transition table 19. This action occurs in response to the set of user inputs 16 of FIG. 1 and includes auto-generating the populated state transition table 20 via the host computer 12. Here, the user inputs 16 are used to fill in the various states of the state transition diagram 19, thus creating an output more akin to the state transition diagram 60 of FIG. 7. Method 100 proceeds to block B108 once the populated state transition table 20 has been successfully auto-generated by the host computer 12.

As part of block B106 or in a subsequent step, the method 100 may include receiving, via the host computer 12, one or more containers of meaning (“containers”) in which two or more of the assigned states are grouped together, and also translating such user-assigned containers into a corresponding state hierarchy. As noted above, this action could entail displaying the intuitive drag-and-drop graphic 56 of FIG. 5 to the user 11 via the display screen 14, and thereafter receiving the containers as a user response to the drag-and-drop graphic 56. The host computer 12 could then confirm validity of the various state transitions per event type in each respective one of the containers, e.g., using the ECM 52 of FIG. 1 and programmed validity references or criteria. The host computer 12 could possibly communicate a validity confirmation status signal to the user 11 in response to confirming the validity of the state transitions per event type, e.g., as part of the alert signal (CC₂₂) of FIG. 1. Method 100 then proceeds to block B108.

At block B108 (“T_{CRIT}=T?”), the host computer 12 next performs an error-checking routine on the populated state transition table 20. This action occurs using predetermined error-checking criteria recorded in memory 54 and accessible by the ECM 52 (FIG. 1), and may include searching the populated state transition table 20 for an omitted transition. Events, super-events, and states defined in the modeled system will appear in the transition table 20. Transitions are considered omitted within the scope of block B108 if the transition has not been filled in after the state transition table has been populated. Also, some errors may be identified on the basis of the container's identity or the state and event criticality level. Omitted critical transitions could be highlighted in the populated state transition table 20 as noted above to guide the user 11 into further consideration. For example, the host computer 12 could create a color-coded background, outline, or text color for certain transitions in the populated state transition table 20 to draw the user's attention to such transitions. As the host computer 12 makes all possible combinations of states and events explicit, the user 11 must fill in every cell, thus protecting against inadvertent omissions of transitions. The method 100 thereafter proceeds to block B109 when the host computer 12 affirmatively detects an omitted transition, and to block B112 in the alternative when the host computer 12 does not detect omitted transition.

Block B109 (“ALRT”) includes communicating an alert to the user 11 in response to the omitted transition. For example, the host computer 12 could display a visual alert message or graphic on the display screen 14 of FIG. 1, thereby giving the user 11 an immediate visual indication of the omitted critical trait. Alerts could be augmented with auditory or haptic feedback in some implementations. Graphics could include highlighted portions of the populated state transition table 20 to draw the user's attention to omitted traits, as noted above, some of which may be function-critical and thus important to design into the FSM of the modeled system. Method 100 then proceeds to block B110.

At block B110 (“UPDT (16)”), the host computer 12 shown in FIG. 1 may receive updated user inputs 16 from the user 11 to fill in the populated state transition table 20, thereby generating an updated version of the populated state transition table 20. In this block or one of the previously described blocks, the host computer 12 could receive one or more user-defined compound events as a combination of events as described above, and then update the populated state transition table 20 with the user-defined compound event(s).

Block B110 could optionally include receiving a customized event query from the user 11 via the host computer 12, as described above with reference to FIG. 8, with the customized event query describing one or more hypothetical combinations of the events. In response to receipt of such queries, the host computer 12 could determine results of the event queries and update the populated state transition table 20 with the results. The method 100 thereafter returns to block B106 which is described above. Blocks B102-B110 are therefore intended herein to be iterative, with the user 11 being prompted to refine the populated state transition table 20 through multiple iterations. This occurs until the user 11 is satisfied with the completeness and accuracy of the populated state transition table 20, or until the host computer 12 of FIG. 1 no longer detects errors or omissions in the populated state transition table 20.

Block B112 (“GEN STTF”) includes generating the final state transition table 21 of FIG. 1 as an output file. The final state transition table 21 in an optimal implementation of the method 100 would include every possible state, state transition, and event/event combination of the modeled system, and would also encompass function-critical states relevant to the particular modeled system. In keeping with the non-limiting motor vehicle example set forth above, for instance, the host computer 12 and execution of the method 100 would ensure that automated driver protection systems, stability, traction, steering, braking, lane keeping, and other possible automated driver assist functions are fully considered, e.g., when developing HMI software for use by an operator of such a motor vehicle.

While it is conceivable that some non-critical functions could be omitted for complex modeled systems, the present approach should fully capture function-critical behavior of the modeled system. In this manner, the final state transition table 21 is ready for use in developing an actual production-ready system. As appreciated by those skilled in the art, an error-tested and complete version of the final state transition table 21 may be used to develop corresponding state transition diagrams and underlying computer code, such as to program an HMI device or control system to perform various actions in response to dynamically changing circumstances. Likewise, the actual system will be less likely to enter non-defined or terminal states having no exit, or resulting in racing or competing conditions in which the state transition outcome may vary in an unpredictable manner.

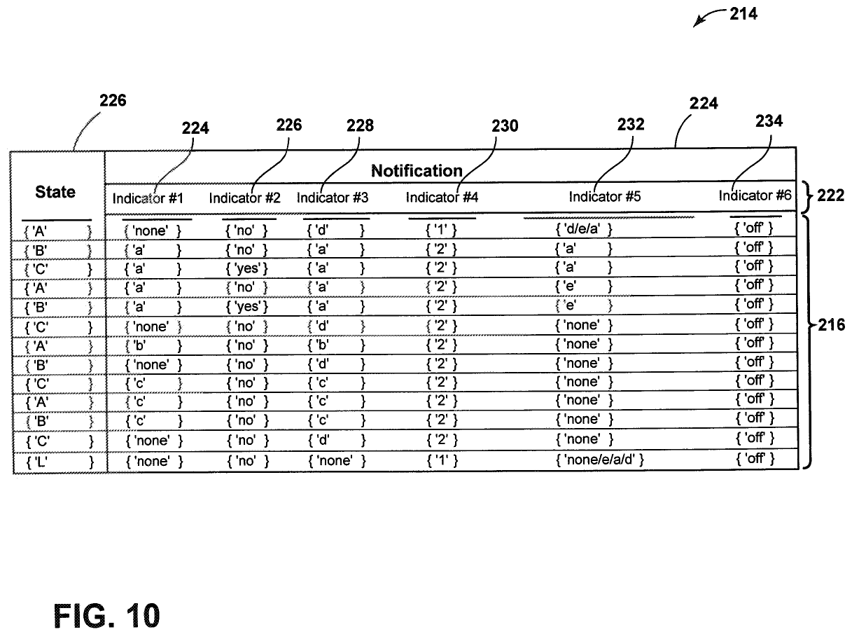

One-limiting aspect of the present disclosure relates to the modeling system 10 including a distinctiveness tool 51. The distinctiveness tool 51 may be configured for characterizing notification 216 distinctiveness of an FSM-modeled system. The distinctiveness tool 51 may employ FSM techniques to delineate and measure distinctiveness of feedback provided for the state transitions. FIG. 10 illustrates a feedback table 214 in accordance with one non-limiting aspect of the present disclosure. The feedback table 214 illustrates a plurality of notifications 216 configured for providing feedback for current states and state transitions. The notifications 216 may be intended to provide reasonably perceptible, noticeable, visible, and/or cognitively clear cognitively clear notifications 216 as feedback to a user, a machine, or other entity. This may be beneficial when completing one or more of the state transitions, i.e., when transitioning between states. The notifications 216 are shown for exemplary purposes to correspond with a collection of indicators 222 useful for providing feedback. A notification column 224 may include a plurality of rows, with each row representing a notification 216 to be presented while the modeled system is at the corresponding one of the states listed in a state column 226. The notifications 216, or more specifically the information, content, etc. of each notification 216, may be selected from a collection of indicators 222. The collection of indicators 222 may include one or more visual, auditory, haptic, and/or other type of attributes.

The indicators 222 may themselves be further definable to include one or more of a plurality of selectable attributes, however, there may be a different number of indicators 22 depending on the modeled system. The attributes may be individually selected to define granular parameters for the collection of indicators 222 to be included within the corresponding notification 216. The feedback table 214 is shown for non-limiting purposes with respect to the notifications 216 being generated according to a first indicator 224, a second indicator 226, a third indicator 228, a fourth indicator 230, a fifth indicator 232, and a sixth indicator 234, with each of the indicators 224, 226, 228, 230, 232, 234 including variables for one or more of a plurality of selectable attributes (not individually labeled). Further indicators 222 may be included, included indicators for sound and haptics. The selectable attributes for the first indicator 224 may be selected from a first listing of available attributes, which are shown to correspond with a listing of light color outputs, such as no color (none), color a, color b, color c, etc. The selectable attributes for the second indicator 226 may be selected from a second listing of available attributes, which are shown to correspond with defining a blinking feedback, such as no blinking (no) and blinking (yes) and/or a blinking pattern-a function of the pulsation frequency, envelope shape, and the inter-stimulus duration of the pulsations, which may also be adapted to the urgency of the message or state. The selectable attributes for the third indicator 228 may be selected from a third listing of available attributes, which are shown to correspond with an icon color output, such as no color (none) and colors a, b, c, d. The selectable attributes for the fourth indicator 230 may be selected from a fourth listing of available attributes, which are shown to correspond with defining an icon position, such as a primary position (1) and a secondary position (2). The selectable attributes for the fifth indicator 232 may be selected from a fifth listing of available attributes, which are shown to correspond with a color display sequence, such as no color (none) and/or combinations of colors a, b, c, d, and e. The selectable attributes for the sixth indicator 234 may be selected from a sixth listing of available attributes, which are shown to correspond with a flasher setting display sequence, such as no flashing (off) and flashing (on) and/or other configuration capable of rendering a generic identity.

The notifications 216, or more specifically the indicators 222 and/or attributes associated therewith, are merely illustrative of a vast variety of variables that may be utilized for the notifications 216. This is done for exemplary and non-limiting purposes as the present disclosure fully contemplates other types of notifications 216 being utilized, including notifications 216 that may be interfaced with other systems, machines, computers, entities, etc., optionally without user interaction. The present disclosure also contemplates the notifications 216 being employed with other types of modeled systems besides motor vehicles, such as the above-noted aircraft, watercraft, rail vehicle, dynamic or static system, medical device, powerplant, etc. The notifications 216 presented in FIG. 10 are merely exemplary of diverse notifications 216 that may be generated according to an extensive collection of indicators 222, attributes, and variables. The notifications 216 may be correspondingly generated depending on the activities of the modeled system such that the present disclosure fully contemplates the indicators 222 including a widespread combination of visual, auditory, haptic, or other types of attributes, including those that may be considered as machine or computer attributes, at least in so far as being intended for interfacing with a machine as opposed to an individual, e.g., to provide data, information, metrics, etc. as feedback to another system. Non-verbal auditory content may be distinguishable on the basis of the selected timbre, pulse duration, pulse rate, frequency, loudness, etc. Haptic content may be distinguishable on the basis of the pulse pattern, inter-pulse-interval, pulse duration, pulse repetition rate or number of pulses, vibration intensity, etc.

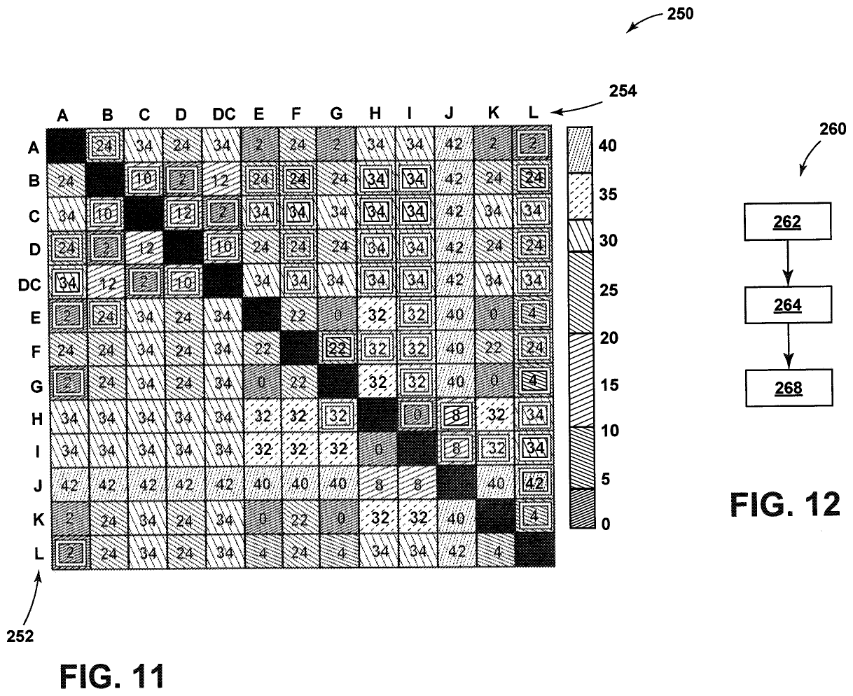

The distinctiveness tool 51 may be configured to utilize the properties of each notification 216 to facilitate generating a distinctiveness rating for the corresponding notification 216. The distinctiveness tool 51, in other words, may be configured to generate distinctiveness ratings for each of the notifications 216 based on the indicators 222 and attributes associated therewith. One non-limiting aspect of the present disclosure contemplates generating the distinctiveness ratings for each of the state transitions. The distinctiveness ratings may be used in this manner to comparatively quantify relative distinctiveness between the notifications 216 for each state transition based on differences between a transitions-from state and a transitioned—to state associated therewith. FIG. 11 illustrates a distinctiveness abstraction table 250 in accordance with one non-limiting aspect of the present disclosure. The distinctiveness abstraction table 250 may be configured for visually displaying distinctiveness ratings generated for each of the state transitions. The state transitions may correspond with activities, events, etc. associated with transitioning from one state to another state, i.e., from a transitioned-from state to a transitioned-to state. The distinctiveness abstraction table 250 may include cross-referencing a plurality of cells relative to a transitioned-from one of the states and a transitioned-to one of the states, which are shown for non-limiting purposes to correspond with the transitioned-from states being listed along a vertical axis 252 and the transitioned-to states being listed along a horizontal axis 254.

The distinctiveness abstraction table 250 may be used in this manner to delineate each of the state transitions according to FSM principles. The distinctiveness rating included within each of the cells may be utilized to represent distinctiveness of the notification 216 associated with the related state transition. The distinctiveness ratings may be used in this manner to quantify relative distinctiveness between the notifications 216 for the transitioned-from and transitioned-to states associated therewith. The distinctiveness ratings may be used to represent or otherwise normalize a degree by which the notification 216 at a start of a state transition differs from a notification 216 at an end of the corresponding state transitions. The distinctiveness rating, in other words, may be configured to represent or normalize a degree by which a transitioned-from notification differs from a transitioned-to notification. The capability to provide a distinctiveness rating for each of the state transitions may be beneficial in assisting a designer, a software program, etc. in ascertaining information beneficial in comparing whether the modeled system provides reasonably perceptible, noticeable, visible, and/or cognitively clear notifications 216 as feedback to a user, a machine, or other entity upon completing one or more of the state transitions. The distinctiveness ratings may be used to quantify differences between the notifications 216 according to size, saliency, etc. of the indicators 222 and attributes associated therewith.

One non-limiting aspect of the present disclosure contemplates including one or more values, metrics, or other factors as part of the distinctiveness ratings. The distinctiveness ratings, as such, may be presented in various forms, optionally including a combination of alphanumeric text, indicia, icons, callouts, color coding, and the like. FIG. 11 illustrates the distinctiveness ratings being configured for non-limiting purposes to each include a value, a color coding, and a feasibility callout. The values may be derived from assigning a value to each of the attributes and generating the distinctiveness ratings as a function of differences between the values for the transitioned-to and transitioned-from notifications associated therewith. The distinctiveness ratings may be calculated to be proportional to a delta difference between the values for the transitioned-to and transitioned-from notifications associated therewith.

The values included as part of the distinctiveness ratings may be generated as a difference between a summation of the weighted values assigned to each of the attributes 222 of each notification 216. The following equation may be used to calculate the value as a number:

$$N = w\_ 1 * \vert f\_ 1 - t\_ 1 \vert + w\_ 2 * \vert f\_ 2 - t\_ 2 \vert + ... . \qquad ( eq . 1 )$$

where w_1, w_2, etc. are weights, f_i is the value assigned to a single indicator at “from” state, and t_i is the value assigned to a single indicator at “to” state.

The following equation may also be used:

$$N = w\_ 1 * c\_ 1 + w\_ 2 * c\_ 2 + ... .$$

where c_i=0 i_ffi=t_i and c_i=1 iff_i!=t_i (eq. 2) The operator!=represents strict inequality.

The number (N) may be used in this manner for representing a magnitude of a delta difference between the distinctiveness rating, value for the notifications 216 of the associated state transition.

The color coding or other visual representation, such as shading, included as part of the distinctiveness ratings may be calculating for representing a color magnitude of the delta difference for the distinctiveness rating associated therewith. The illustrated color coding is shown to be confined relative to a color coding map 258, whereby the color coding map 258 translates the number to a visual indicator 222, which for exemplary purposes shown to correspond with darker colors representing less distinctiveness and brighter colors representing greater distinctiveness.

The feasibility callout may be a visual representation included as part of each of the distinctiveness ratings shown for non-limiting purposes to correspond with a box-shaped callout being presented or omitted from the related cell. The feasibility callout may be based on a determination made as to whether the corresponding state transition is determined to be one of feasible and infeasible. FIG. 11 illustrates a plurality of solidly colored cells devoid of a distinctiveness rating due to the corresponding cells aligning with state transitions whereby the notifications 216 associated therewith may be incapable of being reached or used. A state transition from state A back to the same state A may be infeasible and/or irrelevant for notification 216 purposes since the corresponding notifications 216 would be the same. The state transitions in FIG. 11 may be included within the distinctiveness abstraction table 250 for purposes of theoretical possibility and/or to meet FSM principles for generating a truth table or other tabulations of each notification 216. It may, however, be impossible, impractical, or otherwise infeasible for the modeled system to undertake the corresponding state transition or to undertake the corresponding state transition while operating within normal operating boundaries or capabilities. The feasibility callout may be used in this manner to indicate the state transitions, thereby the corresponding distinctiveness ratings, associated with state transition team to be feasible. Another approach to account for the state transition feasibility may be based on the color being omitted or removed for those state transitions determined to be infeasible.

The distinctiveness abstraction table 250 is believed to be beneficial in providing an output that the host computer 12 or other device operable in according with the present disclosure may generate from processing of the state transition table 60 and the feedback table 214. The host computer 12 and/or another entity operable with the modeled system may include corresponding non-transitory instructions stored on a computer-readable storage medium, which when executed by one or more processors, may be sufficient to facilitate generating and/or presenting the distinctiveness ratings in the manner described herein, i.e., through the distinctiveness abstraction table 250 in a manner that may be visually interfaced with an individual and/or in another manner that may generate an equivalent file or data construct capable of being provided to another computer or logically programmed entity. The distinctiveness tool 51, accordingly, is believed to be a substantial, technological, and functional improvement capable of realizing the underlying computation processes and logical procedures described herein in a manner that an individual operator themself may be unable to replicate and in a manner that renders and transforms the underlying information into a significantly more helpful and beneficial form.

FIG. 12 illustrates a flowchart 260 of a method for characterizing the notification 216 distinctiveness in accordance with one non-limiting aspect of the present disclosure. The method may be utilized to facilitate characterizing notification 216 distinctiveness for an FSM-modeled system or other system whereby it may be desirable to provide users, machines, computers, etc. notifications 216 as feedback when system transitioning from one state to another, i.e., upon reaching a newly, transitioned-to state. Block 262 relates to an analysis process whereby a tabulating module or other feature of the host computer 12 may be configured for determining a state transition table 60 for the FSM-modeled system. The state transition table 60 may correspond with that illustrated above in FIG. 7 whereby a plurality of state transition between a plurality of states 63 may be identified, with each state transition event defining a rule for transitioning from a transitioned-from one of the states to another transitioned-to one of the states. Block 264 relates to a distinctiveness or other feature the host computer 12 may be configured for generating a distinctiveness in this rating for each of the state transitions based on comparatively quantify relative distinctiveness with between the notifications 216 for the transition-prompt and transitioned-to state associated therewith. The distinctiveness ratings may be generated in a manner described above with respect by arranging the distinctiveness ratings within a distinctiveness abstraction table 250 for visual inspection and/or by distributing the distinctiveness ratings in another form, e.g., table, electronic data set, etc. Block 268 relates to a distinctiveness analysis process whereby the distinctiveness tool 51 and/or another feature of the host computer may be configured for processing the distinctiveness abstraction table 250 other distinctiveness output from Block 264. The distinctiveness analysis process, for example, may include the host computer out of the distributors to automatically identifying or otherwise drawing attention to distinctiveness ratings below a desired threshold, such as a threshold selected according to design parameters.

The distinctiveness tool 51 and other features of the present disclosure may be useful in improving identification of HMI perceptible, noticeable, visible, and/or cognitively clear issues of state transitions in a formal manner (verification), automatic highlighting of topics for focused empirical validation, increasing the speed and accuracy of HMI design process, and/or automating verification of notifications for state transitions. The system, for example, may be useful with advanced automated systems consisting of multiple modes, and system states within modes, each referring to a different control behavior and responsibility of the system whereby transitions between system modes and states may be apparent to the user to promote correct understanding and appropriate use behavior. The present disclosure proposes a state transition visibility tool (STVT) or other tool configured for multiple modalities to identify HMI notification issues. The verification can be done manually by visual inspection, or automatically by a computerized system, such as based on a description of the system modes, as a state transition table with a set of visual characteristics, whereafter a systematic assessment of HMI notifications according to a set of rules may be generated. Modern automated systems may be extremely complex as such systems may include various modes and transition rules, some of which are executed automatically while others are based on various timers with hidden logic.

The system 10 of FIG. 1 may involve interaction of the user device 12 and a design optimization platform 26. In general, the present approach involves receiving the FSM data 110 associated with a set of domain knowledge rules, with optional randomization of the characteristics associated therewith, and a system design, including the various states, state transitions, events, and outputs, which as noted above may include details for existing designs 18. The existing designs 18, the final state table 21 and/or other information described in FIG. 1 may be included with or fully embody the FSM data 110. As contemplated herein, the design optimization platform 26 may utilize iterative modeling of domain knowledge rules for predictably ranking state flow representations of the FSM-modeled system according to one or more of user experience, usability, correctness, transformability, effectiveness, and readiness.

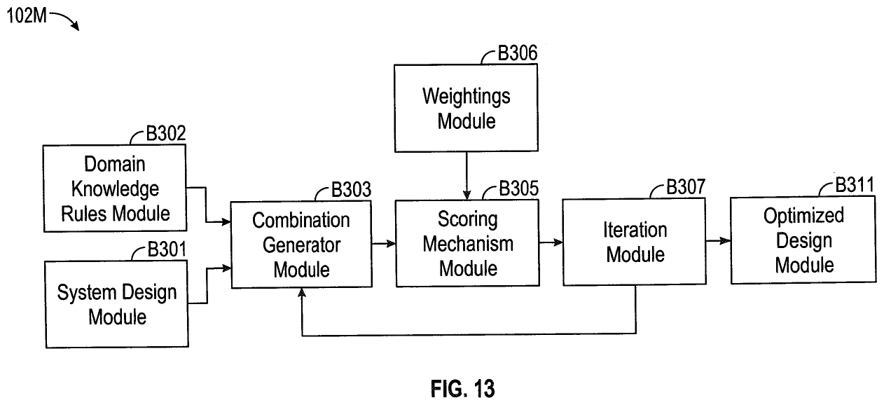

A control action may then be performed in response to identifying an optimized design as set forth below. For instance, nominal states S1, S2, S3, and S4 may be specified in the FSM data 110, potentially with data that describes static properties, dynamic properties, structural properties, states, state transitions, events, and outputs of the FSM-modeled system. As part of the present method 102M of FIG. 13, the design optimization platform 26 could thereafter perform one or more control actions associated with optimizing the behavior, for instance by indicating the optimized design, i.e., a one or more state flow representations for the FSM-modeled system having a highest ranking.

Referring now to FIG. 13, a logic flow diagram is shown that illustrates an embodiment of the present method 102M. The logic flow diagram is constructed from constituent logic segments or blocks, with each block implemented manually and/or automatically as needed, e.g., as one or more algorithms or code segments. Those skilled in the art will appreciate that the flow diagram of FIG. 13 also lends itself to the implementation of constituent hardware/software modules each configured to perform the associated tasks. Thus, the terms “block” and “module” are used hereinbelow synonymously.

Block B301 (System Design Module) feeds into method 102M to enable the user device 12 of FIG. 1 to receive data associated with the design of the FSM-modeled system (“system design”). The system design module/Block B301 provides as complete a record as possible of the states, state transitions, events, and user-facing indications (“outputs”) of the FSM-modeled system. The system design may include data describing static properties, dynamic properties, structural properties, states, state transitions, events, and outputs of the FSM-modeled system. Block B301 is configured for constructing a viable system design for the FSM-modeled system. As appreciated in the art, this effort in turn involves the generation and error-checking of one or more state transition tables and/or transition diagrams, e.g., using the automated approach described in U.S. patent application Ser. No. 18/318,006, filed on May 16, 2023, which is hereby incorporated by reference in its entirety, or using another sufficiently developed state transition table, e.g., the final state transition table 21 of FIG. 1. Such data is received at block B302 as inputs to the method 102M.

Block B302 (Domain Knowledge Rules Module) feeds into method 102M to enable the user device 12 of FIG. 1 to receive data associated with a plurality of domain knowledge rules. The domain knowledge rules, for example, may be used to at least partially define domain alternatives for one or more of the states, state transitions, events, and outputs of the FSM-modeled system. Block B302 may be configured for optionally utilizing a randomization process for randomizing or otherwise expanding upon the domain knowledge rules. Block B302 may be configured to generate a plurality of domain alternatives in this manner. The domain alternatives may be used with Block B303 (Combination Generator Module) as a mechanism for subjecting the system design to various simulations, test, sequences, etc. for purposes iteratively optimizing the system design through convergence to the optimized design.

Block B303 relates to generating a plurality of stateflow representations for the FSM-modeled system according to the domain alternatives. The stateflow representations may be used for reflecting behavior of the FSM-modeled system when operating according to one or more of the domain alternatives. The stateflow representations may correspond with datasets, tables, diagrams, etc., which may be prepared to include metrics, values, statistics, and other suitable information for modeling the system design according to the domain alternatives without having to visually or physically produce actual stateflow diagrams. The stateflow representations may be beneficial in this manner for improving recognition of the FSM-modeled system when behaving according to the domain alternatives, which may be beneficially done without requiring a design team to physically depict the states, state transitions, interactions, outputs, etc.

The stateflow representations modeled according to the domain alternatives, i.e., various characteristics, randomization, options, etc., may be fed to Block B305 (Scoring Mechanism Module). Block B305 may be configured for generating a score for each of the stateflow representations. Each score may be used for ranking a corresponding one of the stateflow representations based at least in part on one or more of user experience, usability, correctness, transformability, effectiveness, and readiness. Block B306 (Weightings Module) may be configured for assigning weight values to be used by Block B305 in calculating the model scores. The weighted values may be variable to account for different contingencies, measure the influence of different alternatives on system performance, etc.

To further enhance the analysis performed based on the domain knowledge rules and/or the randomization thereof, Block B307 (Iteration Module) may be employed to iterate or otherwise adjust the domain alternatives used when calculating the scores. Block B307 may be used in this manner to automatically vary the domain alternatives, i.e., the domain rules, and/or the randomization thereof, to provide additional characteristics, scenarios, etc. for use in additionally iterating operation of the FSM-modeled system. The iteration of the domain alternatives, i.e., the generation of iterated alternatives, may be performed based on the scores. This may be useful in automatically generating the iterated alternatives based on prior scoring analysis performed for the FSM-modeled system, such as to further test and simulate for specific scenarios. Block B107 may be configured for iterating the domain knowledge rules, such as one configured to operate as a genetic algorithm and/or a local search algorithm.

The iterated alternatives may be fed to Block B303 for use in generating a plurality of iterated stateflow representations for the FSM-modeled system. The iterated stateflow representations may be used for reflecting behavior of the FSM-modeled system when operating according to one or more of the iterated alternatives. The iterated stateflow representations may be similar to the above-described stateflow representations, with a further benefit of varying the analysis of the FSM-modeled system to automatically account for potentialities that may have not been addressed with the user input of the domain knowledge rules. Block B305 may be configured for generating iterated scores for each of the iterated stateflow representations. The iterated scores may be generated, weighted, or otherwise calculated in a manner identical to the stateflow representations so as to provide normalization between the scores and the iterated scores. The capability to generate iterated scores based on user inputs (scores) as well as based on computer-generated inputs (iterated scores) may be beneficial in improving behavior of the FSM-modeled system beyond the limitations of human inputs.

Block B311 (Optimization Design Module) may be configured for determining an optimized stateflow representation for the FSM-modeled system based at least in part on the scores. The optimized stateflow representation may correspond with a selected one or more of the domain and iterated stateflow representations having the highest ranking based on the corresponding iterated scores. The optimized stateflow representations may be generated in this manner by iteratively creating new models, e.g., domain and iterated stateflow representations, and scoring them until convergence to the optimized stateflow representation is determined. This procedure may be performed multiple times, optionally using different weightings of the scoring mechanism. The scoring or determination of the optimized design may be based on, for example, level of hierarchical (nested) structures (e.g., higher may be better), number of connections between states (e.g., fewer may be better), radius of the diagram (e.g., smaller may be better), space between states (e.g., larger may be better), predefined structures that are known to be good (e.g., more may be better).

The design optimization platform 26 may be configured to utilize stateflow representations that are normally used to represent finite state machines. The design optimization platform 26 may be intended to support designers in improving the quality of their designs, while minimizing design cycle iterations, by using the design optimization platform 26 to automatically generate optimized stateflow representations based on a user's design preferences and computer-iterated alternatives thereto. The design optimization platform 26 may process model data and domain-knowledge data, which may include information or domain rules on generating stateflow representations. The domain rules may include definitions for a correct stateflow representations and rules for transformations on a representation. Examples of definition for a correct stateflow representation may include: each vertex is represented by a closed shape (usually square or circle); each vertex is labeled with unique designator symbols or words written inside them; transitions from one state to another; an edge is usually drawn as an arrow directed from the present state to the next state; the label of a transition rule is written next to the corresponding edge; the initial state is indicated with an arrow with no origin pointing to it; output of each state can be written inside it or in a separate table; and/or a given state can be contained inside a single “parent” state (not more than 1 parent at same hierarchy).

Examples of rules for transformations on a representation may include: adding an edge between two unconnected vertices; removing an edge between two connected vertices; splitting a single state into two separate states; merging two states into a single state; adding edges from each state into the initial state; and/or assigning a direction to an edge (adding “previous/next” relationship). The domain-knowledge data may include predefined rules and may be updated by the user. For example, a user may update the rules regarding the spacing between states for stateflow representations. The model characteristics are properties associated with graph theory. The model characteristics may include, but are not limited to, level hierarchical (nested) structures, a number of connections between states, a radius of the representation, a space between states, and predefined structures. In some implementations, the scoring mechanism, for example, may use a weighted sum of squares of the model characteristics of stateflow representations to assign a score to each stateflow representation, however a wide range of other calculations may also be employed. The optimization algorithm may use a heuristic method for determining an optimized stateflow representation. For example, the optimization algorithm may use a genetic algorithm or a local search algorithm.

Input Data: the user device 12 illustrated in FIG. 1 receives system traits 15 and user inputs 16 from the user 11, with the user inputs 16 filling in the populated state transition table 20, thereby generating an updated version of the populated state transition table 20. That is, following the definitions of states and events and super events, the state transition table is populated automatically. The user 11 then inputs the destination states for each combination. This action could entail receiving various states, state transitions, and events of the modeled system, along with a possible “super-events” (event combinations), conditions (no response to traffic devices), hierarchy definitions, and other system traits 15.

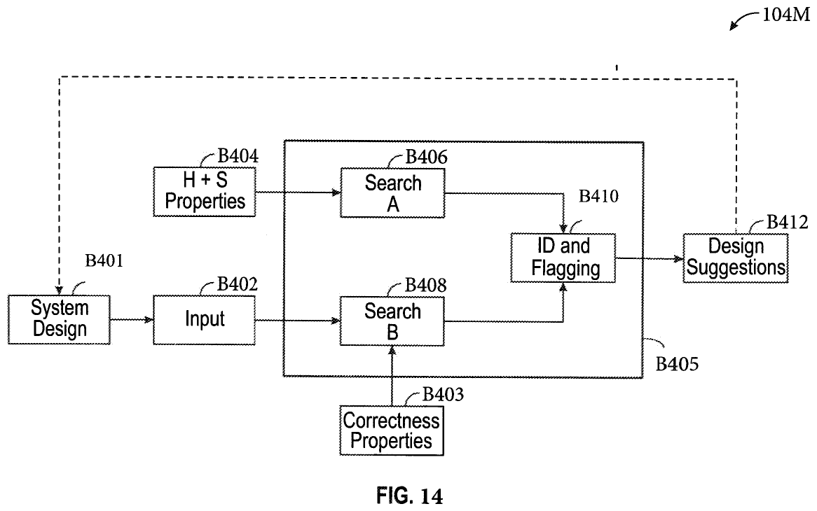

The automated system 10 of FIG. 1 may involve interaction of the user device 12 and a model verification platform 27. In general, the present approach involves receiving the FSM data 110 associated with a system design, including the various states, state transitions, events, and outputs as noted above. The final state table 21 of FIG. 1 may be included with or fully embody the FSM data 110. As contemplated herein, the model verification platform 27 could process and search/analyze the FSM data 110, e.g., via a suitable search algorithm, for the existence of predetermined behavior and/or other desired properties. As part of the present method 104M of FIG. 14, the model verification platform 27 could demarcate, identify, or otherwise “flag” the predetermined behavior as “verified behavior”, with “verified” referring to a post-search state of the flagged behavior. A control action may then be performed in response to the verified behavior as set forth below. For instance, nominal states S1, S2, S3, and S4 may be specified in the FSM data 110, potentially with problematic behavior or other properties such as undefined or poorly defined states or mode transitions as shown. The model verification platform 27 could thereafter perform one or more control actions associated with the flagging the behavior, for instance by outputting a notification 160 to the user device 12 and/or an external device 22 as part of this action.

As noted below, the model verification platform 27 may transmit one or more notifications 160 as specific recommendations for correcting problematic behavior in the system design. For example, recommendations for correcting or better defining transitions between the nominal states S1, S2, S3, and S4 could be part of the notifications 160. The user device 12 as part of such an exchange could receive the notification 160 and possibly provide recommendations to the user 11 in response to the notification 160. In some implementations, the model verification platform 27 may transmit information associated with the identification and location of a problematic behavior or other property that does not include recommendations for correction. In this way, the model verification platform 27 could be used to identify potential design flaws and provide recommendations/suggestions for correcting state tables or stateflow diagrams, and possibly conserve computing resources (e.g., processors, memory, and/or the like) that might otherwise be wasted. Thus, use of the model verification platform 27 facilitates design of an FSM-modeled system, with improved speed and efficiency of the design process and quality of designs being just some of the attendant benefits.

Referring now to FIG. 14, a logic flow diagram is shown that illustrates an embodiment of the present method 104M. Blocks B401 (System Design Module) and B402 (Input Module) feed into method 104M and together enable the user device 12 of FIG. 1 to receive data associated with the design of the FSM-modeled system (“system design”). As contemplated herein, the system design module/Block B401 provides as complete a record as possible of the states, state transitions, events, and user-facing indications (“outputs”) of the FSM-modeled system. Block B401 is configured for constructing a viable system design for the FSM-modeled system. As appreciated in the art, this effort in turn involves the generation and error-checking of one or more state transition tables and/or transition diagrams, e.g., using the automated approach described in U.S. patent application Ser. No. 18/318,006, filed on May 16, 2023, which is hereby incorporated by reference in its entirety, or using another sufficiently developed state transition table, e.g., the final state transition table 21 of FIG. 1. Such data is received at block B402 as inputs to the method 104M.

Block B403 (Correctness Property Module), which may be performed by or made part of the model verification platform 27 of FIG. 1, is configured for generating or constructing a list of generic system behavior, possibly in the form of subjective or objective “correctness” properties. As contemplated herein, such a list of behavior could include desired system behavior, control inputs/outputs, cognitive actions of potential users of the FSM-modeled system, and/or hierarchical structure of the various states, state transitions, events, and other data associated with the current system design. The list of correctness properties or other behavior is then fed into a processing block B405 and its resident blocks B408, B410, and B412.

Block B404 (Hierarchy and Simplification Module) provides additional inputs to the processing block B405. For instance, block B404 could output a list of hierarchy and simplification (“H+S”) properties for the FSM-modeled system in question. While such properties may vary with the intended application, relevant properties may include, e.g., nesting properties defining grouped or related aspects of the defined properties, global events (as opposed to local or private events), consistency features such as common definitions, etc.

Block B405 for its part includes constituent blocks B406, B408, and B410. At block B406 (Search Module A), the above-noted data is analyzed, e.g., the block B406 is configured to search the list of hierarchy and simplification properties from block B404 for a lack of sufficient structural hierarchy, e.g., using a suitable search engine or algorithm as appreciated in the art. The hierarchy and simplification properties are made available as state flow diagrams and/or transition tables, with this block ultimately analyzing the data for a lack of sufficient structural hierarchy. Similarly, block B408 (Search Module B) could use the same or another search algorithm to search the list of correctness properties (or other desired properties) from block B403 for incorrect or otherwise problematic behavior within the scope of the disclosure. Blocks B406 and B408 could then output their respective results to block B410 (ID and Flagging Module), with block B410 thereafter identifying problematic behavior from the generated results.

Problematic Behavior Properties: objectively or subjectively “problematic” or undesirable behavioral properties are then output to block B412 for further action in accordance with a non-limiting embodiment. This action may include flagging each problematic behavior and thereafter performing one or more actions associated therewith. As an example, this action could include transmitting the notification 160 to the user device 12, with the notification 160 possibly including information associated with the identification and location of the problematic behavior or other property.

Block B412 (Design Suggestion Module) could also include generating one or more recommendations for correcting the problematic behavior in this embodiment. Problematic behavior as contemplated herein could include verification properties, structural hierarchy properties, and/or correctness properties. Verification properties within the scope of the method 100M may include a set of predefined properties, wherein the user 11 of FIG. 1 may define the set of predefined properties. The set of predefined properties could be used to verify whether the predefined properties exist in the FSM data 110.

The presence or absence of one or more predefined properties in the set of predefined properties could represent a particular quality of the system design that is associated with the data. Examples of verification properties that subjectively “should” exist, e.g., in the discretion of the user 11, may include clear hierarchical structures, the use of global events to reduce complexity, and the reduction in the number of events (i.e., reduction of multiple “private” events triggered by the same event). In a similar vein, examples of verification properties that “should not” exist may include design structures of the FSM-modeled system that exhibit non-determinism, “racing condition” leading to a livelock, deadlocks, and the likes. The actual system could become unpredictable due to poor indications and perhaps overly complex behavior that the system designers may not have anticipated. Structural hierarchy properties for their part could include nesting, global events, and event consistency as well as inheritance of attributes (from parent to child).

Correctness Properties: within the scope of the method 104M of FIG. 14, correctness properties may include desired system behavior properties, system control properties, and cognitive properties, among other possible properties. System behavior properties are associated with the behavior of a system, and may include, e.g., properties related to (1) non-determinism, (2) error state, (3) augmenting state, (4) restricting state, (5) augmenting actions, (6) delayed actions, and/or (7) intermittent event blocking.

Non-determinism: the non-deterministic nature of this property represents two or more different states having one behavioral manifestation. For example, cases where different states—each representing a different automation behavioral attribute (e.g., driving on the highway vs driving on a traffic light laden route), automation behavior (e.g., escalation protocol), and automation/user control (e.g., lateral/longitudinal)—could have similar behavior manifestation. Another example is that of a car door opening mechanism. Some vehicles have push buttons on the outside door handle that become enabled when key fob proximity is detected. When enabled, a push of this button unlocks the vehicle. However, the driver entering the vehicle does not know when the button is enabled or not (no light is provided). Because the detection mechanism is not 100% reliable, sometimes pushing the button unlocks the doors and sometimes it does not. In other words, the event automatic enablement does not get initiated. Drivers cannot see all of these internal (enable, disable) state changes, and thus from their perspective the system is non-deterministic.

Error state: this next property represents a contradiction between the underlying behavioral model and the representation model which is communicated to the end user. That is, the actual behavioral (implementation) model is in one state, while the representation model is in another state. For example, the implementation model automatically transitions to a state that is not part of the representation model, and not alluded to there.

Augmenting state: continuing with the exemplary properties noted above, this additional property represents a situation in which the requirements demand that a certain state change is possible, but the behavioral (implementation) model does not have such state.

Restricting state: as used herein, the “restricting state” property represents a situation in which the representation model is oblivious to event(s) that can in fact trigger state changes in the finite state machine. When the event takes place, the configuration of the system changes with no accounting for such a change.

Augmenting actions: within the scope of the method 104M of FIG. 14, this property represents situations where the inputs from the user of the FSM-modeled system conflict with automatic inputs. Conflicting actions may be categorized as assisting actions and opposing actions. An assisting action may occur when the automatic inputs reduce the user inputs; thereby, conflicting with the amount of user inputs required. For example, a driver might turn the steering wheel of a vehicle in a specific direction. The automatic input also turns the steering wheel in the same direction as the driver, thereby reducing the amount of torque required by the driver to turn the steering wheel in the specific direction. This can be a problem when the automation ceases its action but the driver is places the same torque inputs as before.

An opposing action may occur in this example scenario when the automatic inputs oppose the user inputs. For example, a driver turns the steering wheel of a vehicle in a specific direction. The automatic input turns the steering wheel in the opposite direction of the driver; thereby, increasing the amount of torque required by the driver to turn the steering wheel in the specific direction. System control properties for their part are associated with system controls affecting the user inputs into the system, e.g., opposing control. Opposing control as contemplated herein represents a situation where the user inputs (e.g., steering wheel rotation) are being opposed by automatic inputs (e.g., Lane-Keeping Assist). Cognitive properties considered in the course of performing the method 104M of FIG. 3 are associated with logic of the FSM-modeled system.

Cognitive properties may include, but are not limited to, e.g., (i) multiple states which share similar set of indications such as illuminated icons, LEDs, etc., but have non-similar behavior (output). This could confuse a user of the physical system as the indications are not consistent with the system behavior, (ii) multiple similar indications with a resulting affordance for a certain behavior, which corresponds to only one of them (or not all of them), (iii) a single state (or a set of states) with corresponding integrated indication. The integrated indication is made up of two or more values, each expressing different characteristic of the system. A user of a certain population segment in which the indication is not readily distinguishable by a certain population segment, e.g., color blind users, may be insensitive to their format and will fail to distinguish between them, (iv) one state with two indications (cases where the same state, and corresponding behavior, is labeled by two different indications), and (v) two internal states with one visible indication, transitioning on the same event into two different control behaviors (e.g., opposing control event in a Lane-Keeping Assist System). Other cognitive properties include situations where the color/shape of the control button is different than what is shown in the display unit. Such lack of consistency will lead to a slower reaction time and worse yet, confusion. For example, the color of the Lane Keep Assist System ON/OFF button in amber, but the color of the indication of the Lane Keep Assist System ON/OFF on the display is white.

Continuing with this discussion, additional cognitive properties could include (vi) two initial and/or intermediate states with one visible indication, transitioning on the same event, into two end states with separate indications and different control behaviors (vii) two initial states with one visible indication, transitioning on a first, identical, event into two intermediate states with one visible indication. The activation of a second, identical, event transitions the intermediate states into two end states with separate indications and different control behaviors (non-determinism with potential delay), (viii) two initial states with separate indications transitioning on the same event, into two end states with separate indications. This refers to cases where the same event (e.g., a similar button push) is used by many states of the system and yields different results depending on the original states. A list of cognitive properties (above) and a corresponding set of ways to deal with them follows.

The model verification platform 27 may generate one or more recommendations/suggestions for correcting one or more flagged problematic properties in a correction algorithm. The correction algorithm may generate one or more recommendations/suggestions based on the flagged problematic properties. The correction algorithm may provide the recommendations/suggestions based on the following non-limiting conditions: (i) two similar indications with corresponding non-similar meaning, e.g., a suggestion to change to a one state indication may be provided to the user 11, (ii) multiple similar indications with a resulting affordance for a certain behavior, which corresponds to only one of them (or not all of them) e.g., a suggestion to change a manifestation in the state that does not require this behavior, such that the affordance is canceled out may be provided to the user 11, (iii) a single state (or a set of states) with corresponding integrated indication. The integrated indication is made up of two or more values, each expressing different characteristic of the system. An end user of a certain population segment (e.g., color blind drivers of a vehicle) may be insensitive to their format and hence fail to distinguish between them. The user 11 could be provided a suggestion or recommendation to add an additional indication property to make the separation distinguishable to eventual end users with perceptual impairments, and (iv) one state with two indications (cases where the same state, and corresponding behavior, is labeled by two different indications), which could result in the notification 160 including a recommendation to change an indication property, or split the initial state into two meaningful states.

Still other examples of cognitive properties in this vein include (v) two internal states with one visible indication, transitioning on the same event into two different control behaviors (e.g., opposing control event in a Lane-Keeping Assist System). This could result in providing the user 11 with a recommendation to change one state indication, (vi) two initial and/or intermediate states with one visible indication, transitioning on the same event into two end states with separate indications and different control behaviors, for abstraction reasons. A notification could be provided before a rare or unexpected state transition with an explanation for the reason for the unexpected transition, (vii) two initial states with one visible indication, transitioning on a first, identical, event into two intermediate states with one visible indication. The activation of a second, identical, event transitions the intermediate states into two end states with separate indications and different control behaviors (non-determinism with potential delay).

In response, the notification 160 could be that a delayed state transition is about to take place once the system can predict this, or (xiii) two initial states with separate indications transitioning on the same event, into two end states with separate indications. Using local rules imposes high memory load on the end-user, in which case the model verification platform 27 could provide the notification 160 presenting subtle cues to the end-user with the transition. This latter action could also entail supporting the memory load of the user device 12 with subtle cues along simple notifications regarding the expected transition. If the event is a user-initiated event, the model verification platform 27 could help the user 11 determine when this behavior is not warranted.

The solutions of the present disclosure therefore provide the user 11 with an improved data verification method that aids in the design and implementation of complex systems. Using the user device 12 and its programmed functionality as set forth above, the user 11 is intuitively guided through verification of system behavior and other predetermined properties. Such behavior could be problematic from the perspective of the user 11 as noted above. Using this methodology, one could describe a system and thereafter verify its design correctness. Since the models are mathematical in nature, it is possible to use computing power to verify them. Verification is done be defining a set of structures, or formal properties (both logical and cognitive as discussed above), that the user 11 wishes to ensure exists, e.g., clear hierarchical structures and the user of global events to reduce complexity, or not exist, e.g., where the system becomes unpredictable to the user 11 due to poor indications, and perhaps due to overly complex behavior. These and other attendant benefits will be appreciated by those skilled in the art in view of the disclosure.

The automated system 10 of FIG. 1 may involve interaction of the user device 12 and a pattern recognition platform 25. In general, the present approach involves receiving the FSM data 110 associated with a system design, including the various states, state transitions, events, and outputs, which as noted above may include details for existing designs 18. The existing designs 18, the final state table 21 and/or other information described in FIG. 1 may be included with or fully embody the FSM data 110. As contemplated herein, the pattern recognition platform 25 could process and search/analyze the FSM data 110, e.g., via a suitable search algorithm, for the existence of predetermined behavior and/or other desired properties, such as to search for or otherwise identify system patterns appearing therein. The system patterns may be determined based on comparison to the existing designs 18 included as part of the FSM data 110. The designer may be correspondingly enabled to annotate problematic or good design patterns so that the system learns the patterns associated therewith. The system can learn to flag bad patterns and also flag good patterns. Overtime it may learn from these annotations to better support a designer during his or her work.

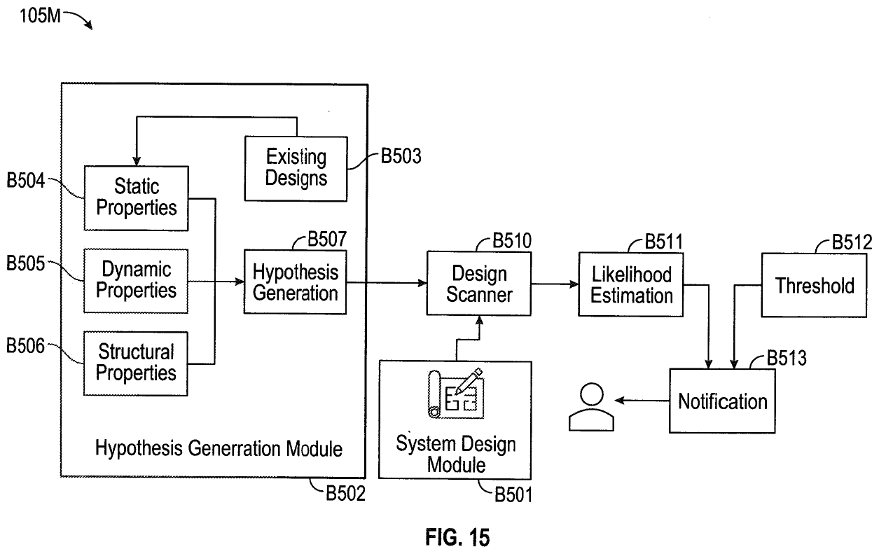

As part of the present method 105M of FIG. 15, the pattern recognition platform 25 may demarcate, identify, or otherwise “flag” the system patterns within the FSM-modeled system, such by indicating each system pattern to be one of “good”, “bad”, or “of interest” to the design team. A control action may then be performed in response to the recognized system patterns as set forth below. For instance, nominal states S1, S2, S3, and S4 may be specified in the FSM data 110, potentially with data that describes static properties, dynamic properties, structural properties, states, state transitions, events, and outputs of the FSM-modeled system. The pattern recognition platform 25 could thereafter perform one or more control actions associated with the flagging the behavior, for instance by outputting a notification 160 to the user device 12 and/or an external device 22 as part of this action.

The pattern recognition platform 25 may transmit one or more notifications 160 as specific recommendations for the system patterns. For example, recommendations for locating and identifying the system patterns relative to the nominal states S1, S2, S3, and S4 could be part of the notifications 160. The user device 12 as part of such an exchange could receive the notification 160 and possibly provide recommendations to the user 11 in response to the notification 160. In some implementations, the pattern recognition platform 25 could be used to identify potential design flaws and provide recommendations/suggestions for correcting state tables or stateflow diagrams, and possibly conserve computing resources (e.g., processors, memory, and/or the like) that might otherwise be wasted. Thus, use of the pattern recognition platform 25 facilitates design of an FSM-modeled system, with improved speed and efficiency of the design process and quality of designs being just some of the attendant benefits beyond processing information in a manner the design team would be unable to undertake individually.

Referring now to FIG. 15, a logic flow diagram is shown that illustrates an embodiment of the present method 105M. Block B501 (System Design Module) feeds into method 105M to enable the user device 12 of FIG. 1 to receive data associated with the design of the FSM-modeled system (“system design”). The system design module/Block B101 provides as complete a record as possible of the states, state transitions, events, and user-facing indications (“outputs”) of the FSM-modeled system. The system design may include data describing static properties, dynamic properties, structural properties, states, state transitions, events, and outputs of the FSM-modeled system. Block B501 is configured for constructing a viable system design for the FSM-modeled system. As appreciated in the art, this effort in turn involves the generation and error-checking of one or more state transition tables and/or transition diagrams, e.g., using the automated approach described in U.S. patent application Ser. No. 18/318,006, filed on May 16, 2023, which is hereby incorporated by reference in its entirety, or using another sufficiently developed state transition table, e.g., the final state transition table 21 of FIG. 1. Such data is received at block B502 as inputs to the method 105M.

Block B502 (Hypothesis Generation Module) feeds into method 105M to enable the user device 12 of FIG. 1 to receive data associated with Block B503 (Existing Designs) of previously modeled systems (“existing designs”). B502 may, for example, consider structural and static properties of existing patterns to form a generalizable hypothesis for future identification of patterns in the FSM-modeled system. A designer may be correspondingly enabled to annotate all structures for which she or he has a hunch that they can be problematic. These may be structures that passed the formal incorrectness verification, yet the designer still feels that it is problematic. The same can be done for “good” properties. The existing design module/Block B503 provides as complete a record as possible of the states, state transitions, events, and user-facing indications (“outputs”) for the existing designs. The existing designs may include data describing static properties (B504), dynamic properties (B505), structural properties (B506) for the states, state transitions, events, outputs, etc., of the existing designs. B502 may include a hypothesis generation process (B507) for generalizing the existing designs, and marking or training based thereon to generate a design analysis model. The design analysis model or similar construct may be used for making potential patterns in the system design for the FSM-modeled system based on the occurrence of corresponding patterns in the existing designs.

Block B510 (Design Scanner Module) identifies one or more system patterns within the FSM-modeled system based on scanning the system design for the FSM-modeled system according to the design analysis model. This may include generalizing a given set of annotated/marked locations of system patterns in existing designs derived in B507 to scan for locations of similar or related patterns in the system design of the FSM-modeled system (“system patterns”). Block B511 (Likelihood Estimation Module) generates a pattern score for each of the system patterns (“pattern scores”). The pattern scores may be determined using any general function, such as but not necessarily limited to at least one of a weighted average or a sigmoid function. Block B512 (Threshold Module) provides one or more threshold scores for comparison with one or more of the pattern scores. The threshold scores may be predetermined from the user device or calculated with the user device. Block B513 (Notifications Module) generates a notification to indicate one or more actions for the FSM-modeled system based on comparing the pattern scores to the threshold scores associated therewith, which may occur on an individual basis for each of the scanned system patterns. The notification may be operable for identifying one or more of the system patterns as at least one of good, bad, and of interest to a design team and/or include an identification and location within the FSM-modeled system for one or more of the system patterns.

In this manner, the design scanner uses pattern matching of graphs to score (estimate) the likelihood of each substructure, similar efforts are done from the static properties' perspective. There is an aggregation and unification of the scores (static and structural) to a single measurement of likelihood. Parts of the system design are being analyzed using the hypothesis generator, eventually, there is a single likelihood estimation for each subgraph for how likely it is to be a pattern, e.g., it may be an estimate of how likely the subgraph could be an instance (or resemble) a bad design pattern. This may be done by using graph matching techniques.

One aspect of the present disclosure relates to recognizing patterns within an FSM-modeled system. The types of patterns recognized may vary depending on a number of factors, such as the patterns derived from annotated or existing designs, i.e., previously developed FSM-modeled systems by other teams and organizations. The patterns, for example, may be used to identify patterns sharing common characteristics indicated by the states and the type of interaction between states. The present solutions are intended to support designers in improving the quality of their designs by automatically identifying both bad and good patterns in their system design. The disclosure describes an automatic identification of fault patterns in a system designed using artificial intelligence methods. The artificial intelligence methods involve training models using state diagrams annotated/marked with the locations of system patterns. The patterns may share common characteristics indicated by the states and the type of interaction between states. The present solutions are intended to support designers in improving the quality of their designs by using a design-scanner platform to automatically identify patterns in a system design, where the identification is based on artificial intelligence models trained with annotated designs. The models are used to identify locations in a design that have a high likelihood of being indicative of a pattern for the design team to consider.

The data may include static properties and structural properties of each state. A static property describes an attribute of a state or an aspect of its behavior. Examples of state properties include, but are not limited to, physical properties, displayable objects with their properties (visual cues), audio cues, textual content, and any other arbitrary properties that are system dependent. A structural property describes the relationship (i.e., topology and patterns of connections) between a state and its actions to other states and their actions, where the relationship is not system dependent. Edges and vertices form structural properties within a design. According to graph theory, a vertex, a point where multiple lines meet (where a point is a particular position in a one-dimensional, two-dimensional, or three-dimensional space). An edge is the mathematical term for a line that connects two vertices. Many edges may be formed from a single vertex. Without a vertex, an edge cannot be formed. A starting vertex and an ending vertex is required for an edge. Structural properties include graph patterns that are used as hypotheses for identifying patterns with the FSM-modeled system. A graph pattern comprising a subset of states and transitions (edges). For example, two or more states that are connected by a bidirectional edge.

The pattern recognition platform 25 may analyze the design data and extract static properties and structural properties from the design data for processing and scoring. The design analysis may analyze the design data in parts and identify the location of the system patterns in the data. For structural properties, graph matching techniques are used to extract the structural properties. Good patterns: hierarchy, global events, logical arrangement, semantic arrangement, criticality arrangements. Bad patterns: no hierarchy, too many local events, illogical arrangement with respect to system operations (e.g., multiple overlapping modes), critical components (e.g., ability to respond to a Traffic Device or not) do not receive proper designation in the state machine diagram. One skilled in the art would readily recognize examples of graph matching techniques, such as a recursive backtracking procedure for solving the subgraph isomorphism problem, a heuristics based analysis, the Glasgow Subgraph solver, etc.

The pattern recognition platform 25 may process the design to determine a design score associated with the design data. Using the extracted static properties and structural properties, the pattern recognition platform 25 may assign a design score to the design data, which is equivalent to assigning a design score to the design. To assign a design score, the pattern recognition platform 25 may use pattern matching of graphs for structural properties and may use a similar method of pattern matching for static properties. The design score may be an aggregate score based on the overall probability of the design data containing a pattern. The aggregate score combines the probability of structural properties containing a pattern and the probability of static properties containing a pattern. The probability of structural properties is based on the structure of subgraph of a stateflow diagram and may be represented by the following equation: P(G=Design Fault|structure(G)).

The probability of static properties is based on the static properties of states and transitions and may be represented by the following equation:

$$P ( G = Design pattern \vert static ( {v}_{1} , {v}_{2} , {v}_{k} ) ) .$$

The aggregate score may be represented by the following equation:

$$P ( G = Design pattern \vert structure ( G ) , static ( {v}_{1} , {v}_{2} , {v}_{k} ) ) .$$

The pattern recognition platform 25 may use a linear scoring method for determining the design score. Examples of linear scoring methods include, but are not limited to, weighted average and weighted sum of the impact factors. The pattern recognition platform 25 may use nonlinear scoring methods for determining the design score. Examples of nonlinear scoring methods include, but are not limited to, sigmoid function (or sigmoid scoring functions). The pattern recognition platform 25 may determine whether the design score satisfies a threshold score. The threshold score represents a likelihood estimation that a design contains a pattern. The threshold score may be predetermined. The threshold score may be updated by a user. The threshold score may be determined automatically by the pattern recognition platform 25 based on artificial intelligence methods and historical data.

The pattern recognition platform 25 may perform one or more actions associated with the design based on whether the design score satisfies the threshold score. Once the design score has satisfied the threshold score, the pattern recognition platform 25 or another module may perform the action of transmitting a notification. The pattern recognition platform 25 may perform the action of providing the data associated with the satisfied threshold to the pattern recognition platform 25 for updating the pattern recognition platform 25. The pattern recognition platform 25 may train a model with historical data. The pattern recognition platform 25 may use one or more artificial intelligence techniques, such as machine learning (i.e., machine learning algorithm), deep learning, and/or the like to train and/or generate a pattern recognition platform 25. The historical data contain static properties and/or structural properties associated with patterns.

After existing system patterns (good, bad, faults, of interest, etc.) are identified, the designs containing the patterns are provided to the pattern recognition platform 25 for training. The pattern recognition platform 25 uses the static properties and structural properties of the designs to determine patterns and to create a model based on the patterns identifying the patterns. The model is used for identifying patterns in future designs. The pattern recognition platform 25 may include a smart data manipulation and integration model based on business rules, a machine learning model, a neural network model, a deep learning model, and/or the like that analyzes a massive amount of data (i.e., an amount of data that cannot be processed objectively by a human actor), recognizes patterns among the data, and makes a prediction without requiring a person to program specific instructions. The pattern recognition platform 25 may separate the historical data into a training set, a validation set, a test set, and/or the like. The training set may be utilized to train the pattern recognition platform 25. The validation set may be utilized to validate results of the pattern recognition platform 25. The test set may be utilized to test the operation of the pattern recognition platform 25.

The pattern recognition platform 25 or another module may train the pattern recognition platform 25 using, for example, an unsupervised training procedure and the historical data. For example, the pattern recognition platform 25 may perform dimensionality reduction to reduce the historical data to a minimum feature set, thereby reducing resources (e.g., processing resources, memory resources, and/or the like) to train the neural network, and may apply a classification technique to the minimum feature set. The pattern recognition platform 25 may use a logistic regression classification technique to determine a categorical outcome (e.g., static properties and structural properties associated with patterns). Additionally, or alternatively, the pattern recognition platform 25 may use a naïve Bayesian classifier technique. In this case, the pattern recognition platform 25 may perform binary recursive partitioning to split the historical data into partitions and/or branches, and use the partitions and/or branches to determine outcomes (e.g., static properties and structural properties associated with patterns). Based on using recursive partitioning, the pattern recognition platform 25 may reduce utilization of computing resources relative to manual, linear sorting and analysis of data points, thereby enabling use of thousands, millions, or billions of data points to train the machine learning model, which may result in more accurate models than using fewer data points.

The pattern recognition platform 25 may use a support vector machine (SVM) classifier technique to generate a non-linear boundary between data points in the training set. In this case, the non-linear boundary is used to classify test data into a particular class. The pattern recognition platform 25 may train the pattern recognition platform 25 using a supervised training procedure that includes receiving input to the pattern recognition platform 25 from a subject matter expert, which may reduce an amount of time, an amount of processing resources, and/or the like to train the pattern recognition platform 25 relative to an unsupervised training procedure. The pattern recognition platform 25 may train the pattern recognition platform 25 using a graph convolutional network (GCN), graph attention network (GAT), graph isomorphism network (GIN), and/or the like. GCN solves node and graph classification tasks. GAT solves node and graph classification tasks by focusing on essential nodes. GIN is used for solving classification problems that involve nodes and graphs by leveraging the structural information of graphs.

The pattern recognition platform 25 may train the pattern recognition platform 25 using a convolutional neural network (CNN) and a recurrent neural network (RNN). A CNN is a deep, feed-forward artificial neural network composed of neurons that have learnable weights and biases. A RNN is feed-forward neural network that focuses on modeling in the temporal domain. The pattern recognition platform 25 may use one or more other model training techniques, such as a neural network technique, a latent semantic indexing technique, and/or the like. For example, the pattern recognition platform 25 may perform an artificial neural network processing technique (e.g., using a two-layer feedforward neural network architecture, a three-layer feedforward neural network architecture, and/or the like) to perform pattern recognition with regard to patterns of the historical data. In this case, using the artificial neural network processing technique may improve an accuracy of the pattern recognition platform 25 generated by the pattern recognition platform 25 by making the pattern recognition platform 25 more robust to noisy, imprecise, or incomplete data, and by enabling the pattern recognition platform 25 to detect patterns and/or trends undetectable to human analysts or systems using less complex techniques.

Optionally, rather than training the model, the pattern recognition platform 25 may obtain the pattern recognition platform 25 from another system or device that trained the pattern recognition platform 25 to generate the pattern recognition platform 25. In this case, the pattern recognition platform 25 may provide the other system or device with the historical data for use in training the model, and may provide the other system or device with updated historical data to retrain the pattern recognition platform 25 in order to update the pattern recognition platform 25. In this way, using the design-scanner platform conserves computing resources (e.g., processors, memory, and/or the like) that would otherwise be wasted in design cycle of a system design because the design-scanner platform alerts users to potential patterns.

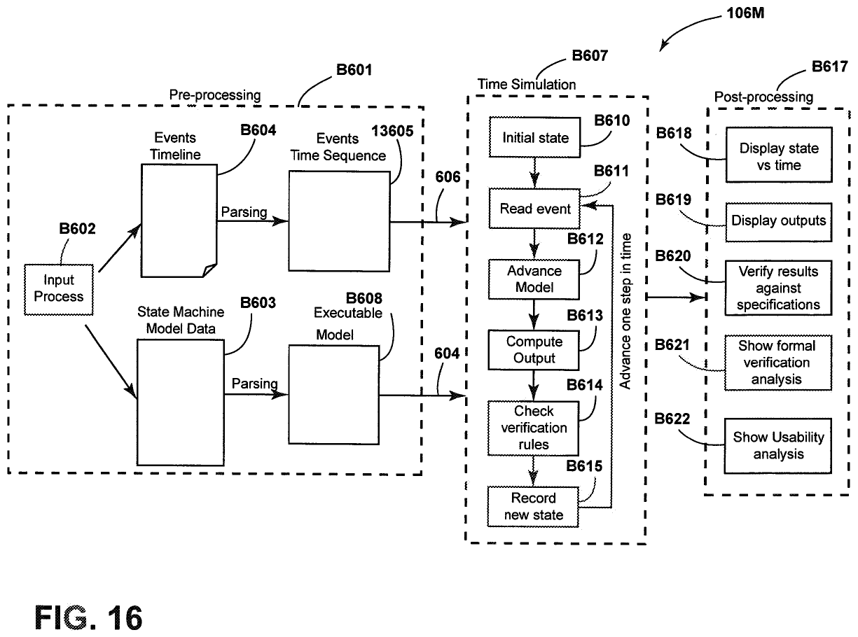

The final state transition table 21 may serve as FSM data 110 associated with the design of the FSM-modeled system, with the FSM data 110 being usable with a scenario testing platform 28 in accordance with the disclosure. The user inputs 16 may also include similar information for existing designs 18 for other existing systems that have been previously reviewed according to FSM processes. The existing designs 18, for example, may include annotations, sequences, best practices, interest, issues, and other characterizations of patterns or pattern inducing elements, features, transitions, etc. therein. The FSM data 110 thus is a starting point for further investigation by the user 11 when performing the method 100M of FIG. 3, i.e., when scenario testing the FSM-modeled system. As part of the present method 106M of FIG. 16, the automated system 10 of FIG. 1 may involve interaction of the user device 12 and the scenario testing platform 28.

FIG. 16 illustrates a flowchart of a scenario testing method 106M in accordance with one non-limiting aspect of the present disclosure. The scenario testing method may be facilitated with the scenario testing platform 28 operable for processing the FSM into scenario testing data. In general, the present approach may include a pre-processing B601. The pre-processing B601 may include an input process B602 for receiving the FSM data 110 associated with a system design. A state machine model data process B603 may process the FSM data 110 to determine the various states, state transitions, events, and outputs for the FSM-modeled system, which as noted above may include details for existing designs 18. The existing designs 18, the final state table 21 and/or other information described in FIG. 1 may be included with or fully embody the FSM data 110. As contemplated herein, the scenario testing platform 28 may process and search/analyze the FSM data 110, e.g., via a suitable search algorithm, for supporting the testing of different scenarios. An events timeline process B604 may be used to detail specific scenarios that may be entered by the user, and the scenario testing platform 28 may also generate random ones. The scenario testing may be specified by a simple timeline whereby each event may be written in plain language, according to basic keywords and syntax, next to the time in which it starts. The following table may be suitable for specifying such a timeline.

| Time | Event |
|---|---|
| 0 | Event description #1 |
| 1 | Event description #2 |
| 2 | Event description #3 |
| 3 | Event description #4 |
| 4 | Event description #5 |
| 5.5 | Event description #6 |
| 5.5 | Event description #7 |
| 7 | Event description #8 |
| 8 | Event description #9 |

An events time sequence process B605 may utilize the textual table to automatically translate the information therein into input signals 606 that may be fed into a time simulation process B607 for use as a simulation state-flow model. Similarly, any executable model process B608 may include generating additional input signals 609 to the time simulation process B607 for representing an executable model for the scenario testing sequence, i.e., the events listed in the timeline table, based on the state machine model derived from the state machine model data process. The capability of the scenario testing platform 28 to perform an events time sequence process B605 and an executable model process B608 based on event timelines and state machine models may be useful in generating inputs to the time simulation process. The time simulation process B107 may include a plurality of sub-processes B610, B611 B615 for automatically performing the scenario testing. The sub-processes may include an initial state process B610 whereby an initial state of the scenario testing may be analyzed, such as with a read event process. The information resulting therefrom may then be subjected to advance model process B611 whereby events associated therewith may be modeled. A computer output process B612 may then generate an output B613 from the advanced model suitable for use with a check verification rules process B614 whereby the events, etc. resulting from the prior sequence of events may be analyzed for clarity, discrepancies, etc. A record new state process B615 may thereafter be performed whereby the initial state may be incremented to a next state in sequence, with the a similar process repeating until each of the subsequent states is analyzed.

Once the simulation is complete, a post-processing B617 may occur whereby the designer may view and inspect the results, i.e., resulting design data, optionally with the FSM model outputs for the simulated scenario along with the active state at each time instance. For a human machine interface (HMI) system, for example, the output design data may be typically of the embodiment presented to the end-user, such as with the post-processing B617 including a display state versus time process B618 whereupon a display output process B619 may use the corresponding information to present the designer with outputs of the scenario testing. A verify results against specifications process B620 may include a review of the corresponding outputs relative to metrics or other information suitable for assessing the corresponding results. A show for a verification analysis process B621 may include a presentation of the results from the verification process. A show usability analysis process B622 may include presenting summaries or other information reflective of system usability relative to the events of the scenario tested. In addition to this general verification, scenario testing platform 28 may be operable for presenting a view of clarity issues as they occur while simulating a specified scenario, which may be helpful in allowing a designer to understand what type of behaviors and conditions may lead to clarity issues, and then attend them accordingly. The designer may also compare results against specifications, e.g., the scenario testing platform 28 may be used to plot the state transitions accruing in a scenario against predefined sequence of states that is anticipated (such information may be entered by the designer separately). Alerts may be given when each state is reached and again after another state is reached, i.e., alerts may be generated as the scenario testing sequences through the plurality of events forming a particularly tested scenario.

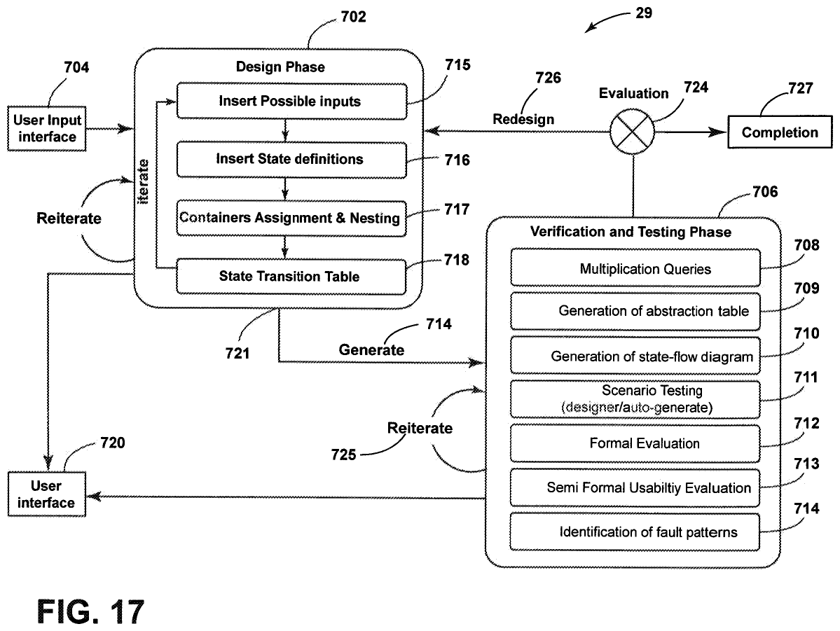

FIG. 17 illustrates an overall modeling platform 29 in accordance with one non-limiting aspect of the present disclosure. The modeling platform 29 may be operable configured for providing a supportive software-based “toolbox” for aiding in the design and implementation of FSM-modeled systems, such as with processor or other computer-based automation and analysis tools capable of leveraging software to improve the limited capabilities of computer systems so as to meaningfully interface testing scenarios, reports, and other information for FSM-modeled system with designers, programmers, etc. The platform 29 may include a design phase module 702 configured for receiving FSM data 110 associated with the design of the FSM-modeled system from a user input or another source 704. The FSM 110 data may be used to describe static properties, dynamic properties, structural properties, states, state transitions, events, and outputs of the FSM-modeled system. The design phase module 702 may be configured for generating design data 719 based at least in part on the FSM data 110. The platform 29 may include a verification and testing phase module 706 configured for providing a plurality of tools 708, 709, . . . 714 operable for utilizing the FSM data 110 and the design data 719 to facilitate aiding in design and implementation of the FSM-modeled system. The verification testing phase module 706 may be configured for determining whether the FSM-modeled system includes undesirable properties or usability deficiencies that may render the design sub optimal. It may also assist the designer in understanding a relation between the design and a hierarchy or other structure of the system and to support for pattern identification that uses annotations of problematic patterns collected from other designs so that similarities between the current design and previous designs can be analyzed, optionally with the inclusion of aid flags highlighting areas for further inspection, e.g., aids operable for drawing the designer's attention to discrepancies between the current design and previous designs identified to be suboptimal.

The design phase module 702 may include a plurality of modules 715, 816, . . . 718. An input module 715 may be configured for receiving inputs 16 entered by a user or other designer, which may form the basis of the FSM data. A state definition module 716 may be configured for importing or otherwise generating semantic information regarding each state of the FSM, such as according to description, implications of being in a particular state, consequences of being in the state, e.g., criticality level, user control, system behavior, and/or auditory, visual, haptic characterizations that may be relevant to the state. The state definition model 716 may additionally include color, size, shape, location, pulsation, etc. for visual characteristics, pitch, pulsation rate, intensity/amplitude, envelope shape, etc. for non-visual characteristics. A containers assignment and nesting module 717 may be configured for showing hierarchy or relations between states as well as separately identifiable groupings for the states, such as groupings sufficient for identifying the states from which the FSM-modeled system may be incapable of being overridden by a user. A state transition table module 718 may be configured for defining a state transition table, such as with the constructs suitable for portraying possible states which may occur upon a given event, transition to another state, etc. and which states will not be possible. The design phase module 702 may be configured for performing iterative processes, such as in the manner described above, with respect to generating design data 719 from the inputted FSM data 110. The platform 29 may include an output module 720 configured for interfacing the FSM data 110 and/or the design data 719 with a designer, i.e., for providing the designer data, graphs, tables, etc. for the FSM-modeled system based on the information generated with the design phase module. The design phase module 702 may be configured to generate a design output 721 to the verification testing phase module 706. The design output 721 may include the FSM data 110 and the design data 719, i.e., a subset or a relevant portion of the data generated with the design phase module.

The verification testing phase module 706 may then process the design output 721 according to a “toolbox” for aiding in the design and implementation of FSM-modeled systems, which may be selectively employed according to aids presented to the designer via a plurality of modules 708, 709, . . . 714. A multiplication queries module 708 may be configured for identifying situations that may be based on combinations of specific event values of interest, which may be used to generate super-events that the designer can use to assess the FSM-modeled system and/or for adding additional states thereto. A generation of abstraction table module 709 may be configured for showing inherent relations between states such that it may be possible to serve the states having a common reference and/or those that may be triggered by a common event or lead to a specific state. The abstraction table may be useful to reflect a structure of the FSM-modeled system. A stateflow diagram generation module 710 may be configured for creating an initial diagram of the FSM-modeled system that may serve as a first draft toward follow-up modification and enhancement, both in terms of system behavior as well as diagrammatic layout. A scenario testing module 711 may be configured for conducting multiple tests of the FSM-modeled system when different events may be triggered according to a set of scenarios chosen by a designer or generated automatically as part of a testing batch. A formal evaluation module 712 may be configured for generating automatic check using the verification properties to avoid including undesirable properties in the FSM-modeled system, and optionally when present, to generate a flag or alert to indicate undesirable properties existence relative to the affected portion of the FSM-model system. A usability module 713 may be configured for checking that the states and transitions comply with these billing guidelines that may be encapsulated within a set of defined properties. A pattern identification module 714 may be configured for collecting information from a variety designs that have portions or aspects of the behavior that may be similar to the current design, e.g., to generate flags or other alerts for relating structures, processes, etc. within the current design to those of part designs, which may optionally be aspects of the prior designs in need of modification.

The platform 29 may include an evaluation platform 724 configured for assessing the results of one or more of the aids and/or other aspects of the verification testing phase module, such as based on a verification testing phase output. The evaluation platform 724 may be configured for presenting statistics, metrics, data, etc. to designer that the designer may then use to facilitate further analysis of the FSM-modeled system. This may include a reiteration process 725 whereby the designer may reiterate or otherwise re-process the FSM data 110 and the design data 719 with the verification testing phase module 706, such as by altering parameters, rules, analysis, etc. for the aids/modules included therein. The verification phase 706 may include a redesign process for generating a redesign input 726 to the design phase module 702. The redesign input 726 may be used to re-start the FSM process, such as by the designer changing parameters, states, transitions, etc. or otherwise deviating from those of a prior user input 16. A completion process 727 may correspond with the designer determining that the results of the evaluation may be sufficient to end the FSM modeling, i.e., after a sufficient redesign process, reiteration, etc., the completion may be determined once the designer has a sufficient supply of information to determine whether the FSM representation of the FSM-modeled system is adequate for the intended purposes.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All values of parameters (e.g., of quantities or conditions), unless otherwise indicated expressly or clearly in view of the context, including the appended claims, are to be understood as being modified in all instances by the term “about” whether or not “about” actually appears before the value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A modeling platform for a finite state machine (FSM) based modeling platform, comprising:
a design phase module configured for receiving FSM data from a user device, wherein the FSM data describes static properties, dynamic properties, structural properties, states, state transition rules, events, and outputs of a design for a FSM-modeled system, wherein the design phase module is configured for generating design data based at least in part on the FSM data; and
a verification and testing phase module configured for providing a plurality of tools operable for utilizing the FSM and design data to facilitate aiding in design and implementation of the FSM-modeled system according to an identification of undesirable properties and usability deficiencies within the static properties, dynamic properties, structural properties, states, state transition rules, events, and outputs of the design.

2. The modeling platform according to claim 1, wherein:
the design phase module includes an input module configured for receiving inputs entered by one or more developers to be included as part of the FSM data.

3. The modeling platform according to claim 2, wherein:
the design phase module includes a state definition module configured for importing or otherwise generating semantic information regarding each state of the design including state outputs.

4. The modeling platform according to claim 3, wherein
the design phase module includes a containers assignment and nesting module configured for indicating hierarchy and relations between states according to separately identifiable groupings of the states.

5. The modeling platform according to claim 4, wherein
the design phase module includes a state transition table module configured for defining a state transition table for the design.

6. The modeling platform according to claim 5, wherein
the verification and testing module includes a multiplication queries module configured for identifying situations based on combinations of specific event values for one or more of the states.

7. The modeling platform according to claim 5, wherein
the verification and testing module includes a generation of an abstraction table configured for defining constructs suitable for portraying possible states that occur upon a given event.

8. The modeling platform according to claim 5, wherein
the verification and testing module includes a stateflow diagram generation module configured for creating an initial diagram of the design to serve as a first draft toward follow-up modification and enhancement.

9. The modeling platform according to claim 5, wherein
the verification and testing module includes a scenario testing module configured for conducting multiple time-simulation tests of the design based on different events triggered according to a set of scenarios.

10. The modeling platform according to claim 5, wherein
the verification and testing module includes an evaluation module configured for identifying existence of desirable as well as undesirable properties relative to an affected portion of the design.

11. The modeling platform according to claim 5, wherein
the verification and testing module includes a usability module configured for assessing whether states and transitions comply with corresponding guidelines encapsulated within a set of defined properties.

12. The modeling platform according to claim 5, wherein
the verification and testing module includes a pattern identification module configured for collecting information from alternative designs for comparison to the design.

13. A modeling platform for a finite state machine (FSM)-modeled system, comprising:
a design phase module configured for receiving FSM data from a user device, wherein the FSM data describes static properties, dynamic properties, structural properties, states, state transition rules, events, and outputs for a design of a FSM-modeled system, wherein the design phase module is configured for generating design data based at least in part on the FSM data; and
a scenario testing module configured for analyzing the FSM and design data to facilitate aiding in design and implementation of the FSM-modeled system based at least in part on subjecting a tested portion of the design to a testing scenario whereby events specified in an event timeline to identify undesirable properties and usability deficiencies within the static properties, dynamic properties, structural properties, states, state transition rules, events, and outputs of the tested portion.

14. The modeling platform according to claim 13, wherein:
the scenario testing module performs:
an events time sequence process to detail specific testing events sequence to be include in the testing scenario, with the testing events therein being entered or automatically generated; and
an executable model process to detail an executable model for the testing scenario.

15. The modeling platform according to claim 14, wherein:
the scenario testing module performs a time simulation process based on pre-processing inputs from the events time sequence process and the executable model process, the time simulation process including a plurality of time sub-processes for performing the scenario testing.

16. The modeling platform according to claim 15, wherein:
the time sub-processes include an initial state process, a read event process, an advance model process, an output process, a check verification rules process, and record new state process.

17. The modeling platform according to claim 16, wherein:
the scenario testing module performs a post-time process on time simulation inputs resulting from the time simulation process, the post-time process including a plurality of post-time sub-processes for identifying undesirable properties and usability deficiencies within the static properties, dynamic properties, structural properties, states, state transitions, events, and outputs of the testing scenario.

18. The modeling platform according to claim 17, wherein:
the post-time sub-processes include a display output process, a verify results against specifications process, a usability analysis process, and a usability analysis process.

19. The modeling platform according to claim 18, wherein:
the scenario testing module may include a verification and testing phase module, the verification and testing phase module additionally including a multiplication queries module, a generation and abstraction table module, a stateflow diagram generation module, an evaluation module, a usability module, and a pattern identification module.

20. A modeling platform for a finite state machine (FSM)-modeled system, comprising:
a design phase module configured for receiving FSM data from a user device, wherein the FSM data describes static properties, dynamic properties, structural properties, states, state transition rules, events, and outputs for a design of a FSM-modeled system, wherein the design phase module is configured for generating design data based at least in part on the FSM data;
a verification and testing phase module configured for providing a plurality of tools operable for utilizing the FSM and design data to facilitate aiding in design and implementation of the FSM-modeled system according to an identification of undesirable as well as desirable properties and usability deficiencies within the static properties, dynamic properties, structural properties, states, state transitions, events, and outputs of the design; and
an evaluation module configured for interfacing results of the verification testing and phase module with a user.
